(19) United States
(12) Patent Application Publication
(10) Pub. No.: US 2026/0084918 A1
(43) Pub. Date: Mar. 26, 2026

(54) SHEET PROCESSING DEVICE, IMAGE FORMING APPARATUS, AND POST-PROCESSING APPARATUS

(71) Applicant: FUJIFILM Business Innovation Corp., Tokyo (JP)

(72) Inventors: Jun SHIBUYA, Kanagawa (JP); Takumi Uegane, Kanagawa (JP); Takayuki Uchiyama, Kanagawa (JP); Taku Kiyomasa, Kanagawa (JP); Takuya Makita, Kanagawa (JP); Hideki Kayashima, Kanagawa (JP); Akira Ito, Kanagawa (JP); Masatoshi Suzuki, Kanagawa (JP); Kazuyuki Koda, Kanagawa (JP); Shota Saito, Kanagawa (JP)

(73) Assignee: FUJIFILM Business Innovation Corp., Tokyo (JP)

(21) Appl. No.: 19/040,617

(22) Filed: Jan. 29, 2025

(30) Foreign Application Priority Data
Sep. 20, 2024 (JP) 2024-164360

(51) Int. Cl. B65H 37/04; G03G 15/00; G03G 21/16

(52) U.S. Cl. CPC B65H 37/04; G03G 15/6544; G03G 15/6573; G03G 21/1633; B65H 2301/51611; B65H 2301/51616; G03G 2215/00827

(57) ABSTRACT

A sheet processing device includes a collecting part configured to collect a plurality of sheets that are carried in; a plurality of lower-end-receiving members with which lower ends of the sheets collected to the collecting part are brought into contact, the lower ends being downstream ends in a carry-in direction; a binder configured to bind a part of an end portion of a sheet batch, the sheet batch being the plurality of sheets collected to the collecting part, the end portion including the lower ends; and a mover-supporter supporting the binder and configured to move the binder around the end portion of the sheet batch in such a manner as to stop the binder at a plurality of stop positions including a plurality of binding positions, in which one of the plurality of lower-end-receiving members is provided on a movable member that is movable in a widthwise direction that intersects the carry-in direction, in which the one lower-end-receiving member is provided with a conjugate movement mechanism configured to move the one lower-end-receiving member in conjunction with a movement of the binder, in which in response to the binder moving in a specific direction toward a predetermined binding position, the conjugate movement mechanism moves the one lower-end-receiving member in the specific direction from a normal position by a predetermined distance, in which in response to the binder moving by a distance greater than the predetermined distance, the conjugate movement mechanism returns the one lower-end-receiving member to the normal position.

### CROSS-REFERENCE TO RELATED APPLICATIONS

This application is based on and claims priority under 35 USC 119 from Japanese Patent Application No. 2024-164360 filed Sep. 20, 2024.

### BACKGROUND

### (i) Technical Field

The present disclosure relates to a sheet processing device, an image forming apparatus, and a post-processing apparatus.

### (ii) Related Art

A post-processing apparatus disclosed in Japanese Unexamined Patent Application Publication No. 2022-179064 (paragraphs 0031 to 0033 and 0038, FIGS. 1, 2, and 5) includes a stapling binding member and a stapleless binding member that are supported by a movable-body-supporting member.

According to Japanese Unexamined Patent Application Publication No. 2022-179064, the movable-body-supporting member includes a support and a guide rail provided on the support.

Furthermore, according to Japanese Unexamined Patent Application Publication No. 2022-179064, a standby position for the stapling binding member and a standby position for the stapleless binding member are defined on the guide rail.

### SUMMARY

Aspects of non-limiting embodiments of the present disclosure relate to a sheet processing device in which a binder is able to perform a binding operation at a predetermined binding position even if one of multiple lower-end-receiving members with which the lower ends of sheets collected to a collecting part are to be brought into contact is located at such a position as to possibly hinder the binder from moving to the predetermined binding position and performing the binding operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet processing device including a collecting part configured to collect a plurality of sheets that are carried in; a plurality of lower-end-receiving members with which lower ends of the sheets collected to the collecting part are brought into contact, the lower ends being downstream ends in a carry-in direction; a binder configured to bind a part of an end portion of a sheet batch, the sheet batch being the plurality of sheets collected to the collecting part, the end portion including the lower ends; and a mover-supporter supporting the binder and configured to move the binder around the end portion of the sheet batch in such a manner as to stop the binder at a plurality of stop positions including a plurality of binding positions, wherein one of the plurality of lower-end-receiving members is provided on a movable member that is movable in a widthwise direction that intersects the carry-in direction, wherein the one lower-end-receiving member is provided with a conjugate movement mechanism configured to move the one lower-end-receiving member in conjunction with a movement of the binder, wherein in response to the binder moving in a specific direction toward a predetermined binding position, the conjugate movement mechanism moves the one lower-end-receiving member in the specific direction from a normal position by a predetermined distance, wherein in response to the binder moving by a distance greater than the predetermined distance, the conjugate movement mechanism returns the one lower-end-receiving member to the normal position.

### BRIEF DESCRIPTION OF THE DRAWINGS

Exemplary embodiments of the present disclosure will be described in detail based on the following figures, wherein:

FIG. 1 is a schematic front view of an image forming apparatus including a sheet processing device according to a first exemplary embodiment;

FIG. 2 is a schematic side view of the image forming apparatus illustrated in FIG. 1;

FIG. 3 is a schematic front view of the sheet processing device according to the first exemplary embodiment;

FIG. 4 is a schematic top view of a part of the sheet processing device illustrated in FIG. 3;

FIG. 5A is a schematic front view of a stapling binder, a mover-supporter, and so forth;

FIG. 5B is a schematic front view of a stapleless binder, a mover-supporter, and so forth;

FIG. 6A illustrates respective standby positions defined for the stapling binder and the stapleless binder;

FIG. 6B illustrates a part of the mover-supporter;

FIG. 7A illustrates dual-flat-binding positions defined for the stapling binder and the stapleless binder;

FIG. 7B illustrates respective corner-oblique-binding positions defined for the stapling binder and the stapleless binder;

FIG. 8 is a schematic side view of a collecting part, lower-end-receiving members, a first conjugate movement mechanism, a second conjugate movement mechanism, and so forth;

FIG. 9 is a schematic perspective view of the lower-end-receiving members, the first conjugate movement mechanism, the second conjugate movement mechanism, and so forth;

FIG. 10 is a schematic perspective view of the first conjugate movement mechanism;

FIG. 11A is a schematic perspective view of one of the lower-end-receiving members, a movable member, a movement urging member, and so forth;

FIG. 11B is a schematic perspective view of a rotatable lever and a rotation urging member;

FIG. 11C is a schematic perspective view of a rotation controlling member;

FIG. 12A is a schematic side view of the first conjugate movement mechanism that is in a normal position;

FIG. 12B illustrates a position of the first conjugate movement mechanism relative to the binder;

FIG. 13 illustrates a position of the first conjugate movement mechanism with the binder moved to a predetermined binding position;

FIG. 14A illustrates a position of the first conjugate movement mechanism during a movement of the binder past the predetermined binding position toward the standby position;

FIG. 14B illustrates a position of the first conjugate movement mechanism with a portion of the binder illustrated in FIG. 14A going out of contact with the rotatable lever;

FIG. 15A illustrates a state where the first conjugate movement mechanism has moved one of the lower-end-receiving members to an avoiding position;

FIG. 15B illustrates a state where the first conjugate movement mechanism has returned the one lower-end-receiving member from the avoiding position to a normal position;

FIG. 16A illustrates a position of the first conjugate movement mechanism immediately before the binder having moved past the one lower-end-receiving member further moves;

FIG. 16B illustrates a position of the first conjugate movement mechanism after the binder illustrated in FIG. 16A has further moved;

FIG. 17 is a schematic bottom view of the second conjugate movement mechanism and so forth;

FIG. 18A is a schematic top view of the second conjugate movement mechanism;

FIG. 18B is a graph exemplifying how the second conjugate movement mechanism moves one of the lower-end-receiving member;

FIG. 19 illustrates the second conjugate movement mechanism that is in a normal position;

FIG. 20A illustrates a position of the second conjugate movement mechanism with the binder moving to start rotating the rotatable lever;

FIG. 20B illustrates a position of the second conjugate movement mechanism with the rotatable lever illustrated in FIG. 20A further rotated;

FIG. 21A illustrates a position of the second conjugate movement mechanism with the binder yet to reach a predetermined binding position;

FIG. 21B illustrates a position of the second conjugate movement mechanism with the binder having reached and stopped at the predetermined binding position;

FIG. 22A illustrates a state where the second conjugate movement mechanism has moved one of the lower-end-receiving members to an avoiding position;

FIG. 22B illustrates a state where the second conjugate movement mechanism has returned the one lower-end-receiving member from the avoiding position to a normal position;

FIG. 23A illustrates a position of the second conjugate movement mechanism with the binder moving from the predetermined binding position to the standby position;

FIG. 23B illustrates a position of the second conjugate movement mechanism with the binder illustrated in FIG. 23A yet to reach the standby position;

FIG. 24A illustrates a position of the second conjugate movement mechanism with the binder having reached the standby position;

FIG. 24B illustrates a position of the second conjugate movement mechanism with the binder illustrated in FIG. 24A starting to move toward an other position;

FIG. 25A illustrates a position of the second conjugate movement mechanism with the binder yet to reach the other position;

FIG. 25B illustrates a position of the second conjugate movement mechanism with the binder illustrated in FIG. 25A having reached the other position;

FIG. 26A is a graph representing the speed of travel of the binder before and after the binder moves past the first conjugate movement mechanism;

FIG. 26B is a graph representing the speed of travel of the binder before and after the binder moves past the second conjugate movement mechanism; and

FIG. 27 is a schematic front view of a post-processing apparatus according to a second exemplary embodiment.

### DETAILED DESCRIPTION

Exemplary embodiments of the present disclosure will now be described.

### First Exemplary Embodiment

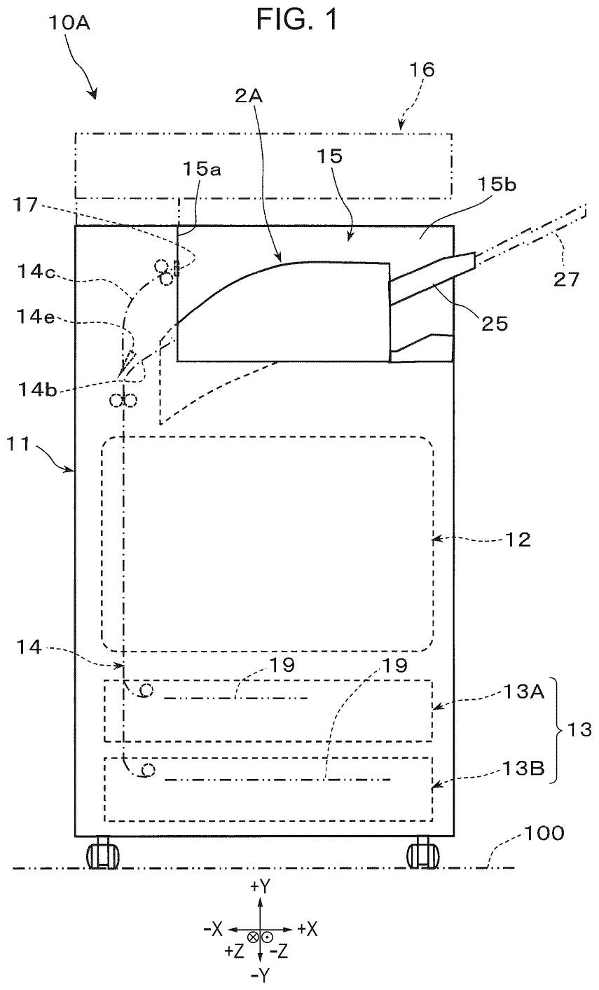

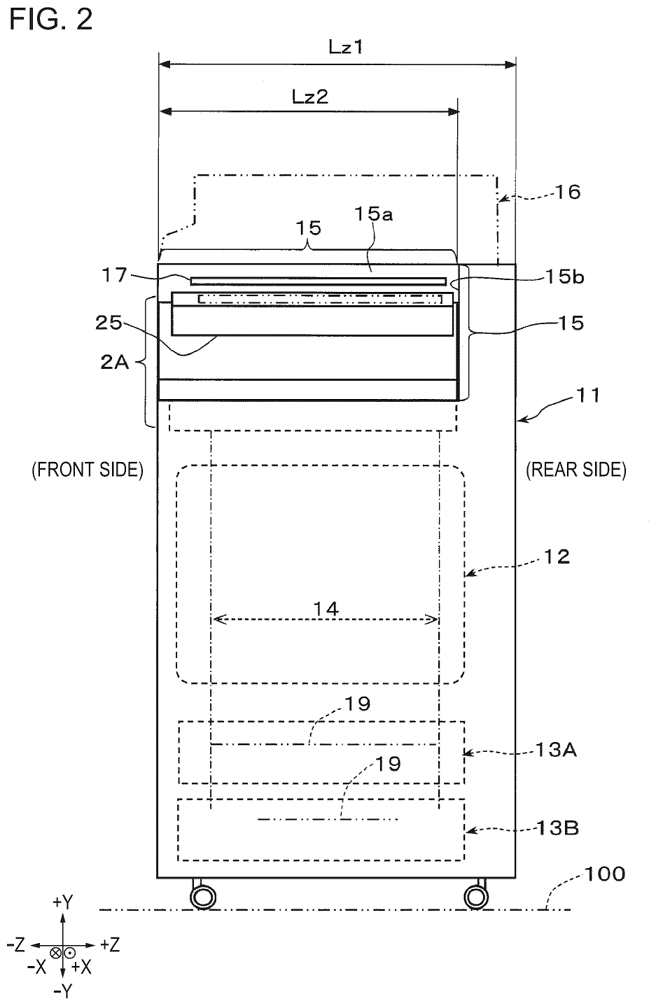

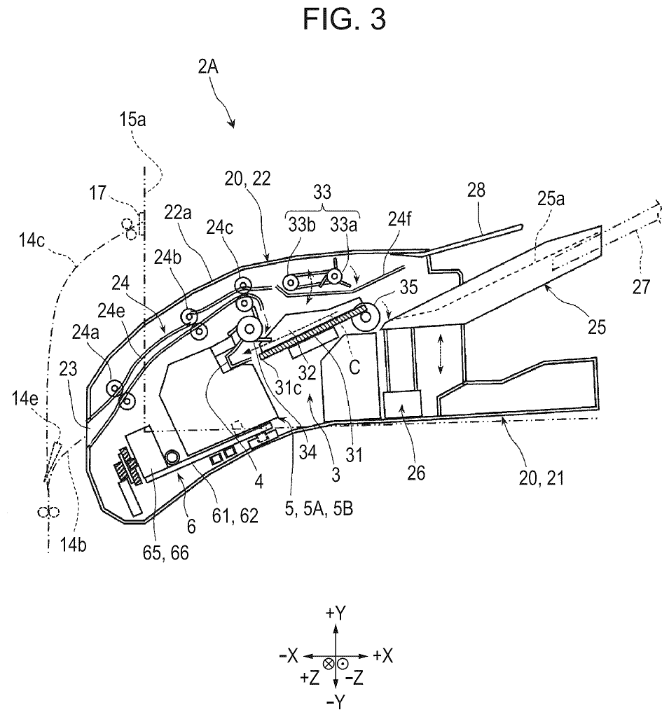

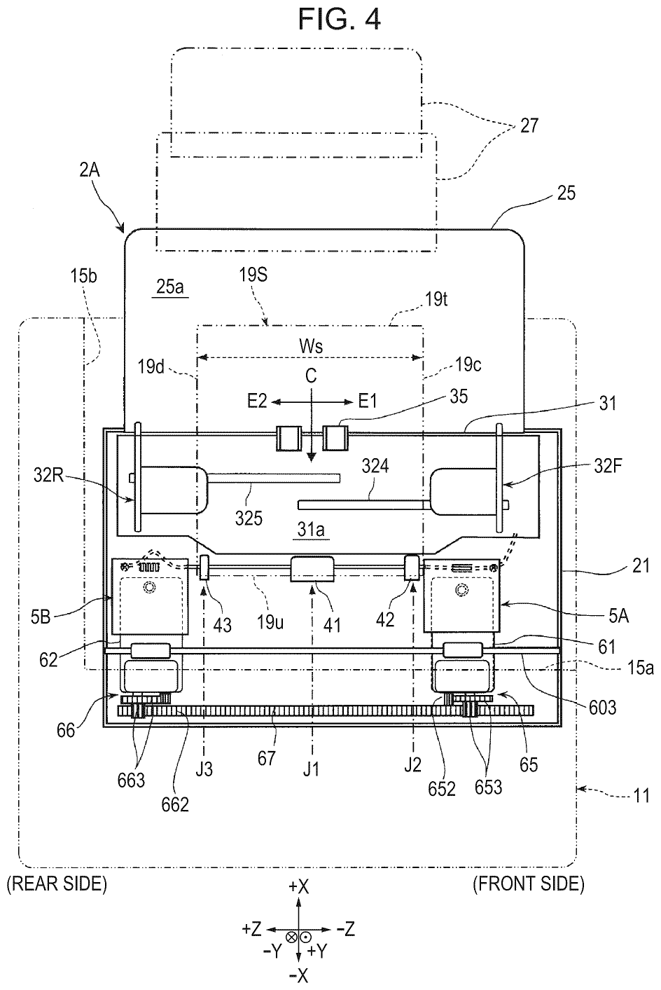

FIGS. 1 and 2 are schematic diagrams of an image forming apparatus 10A, including a sheet processing device 2A according to a first exemplary embodiment of the present disclosure. FIGS. 3 and 4 are schematic diagrams of the sheet processing device 2A.

In this specification and the drawings, elements that are substantially the same are denoted by the same reference signs. In this specification, redundant description of substantially the same elements is omitted.

In FIG. 1 and others, reference signs +X and −X denote the rightward direction and the leftward direction, respectively, of the image forming apparatus 10A in front view. Reference signs +Y and −Y denote the upward direction and the downward direction, respectively, of the image forming apparatus 10A and other relevant elements. Reference signs +Z and −Z denote the rearward direction and the frontward direction, respectively, of the image forming apparatus 10A and other relevant elements in front view.

In FIG. 1 and others, the circle with a cross represents the direction from the near side toward the far side relative to the plane of the page in the drawings. Furthermore, the circle with a dot represents the direction from the far side toward the near side relative to the plane of the page in the drawings.

### (1) Image Forming Apparatus

As illustrated in FIG. 1 and others, the image forming apparatus 10A includes a housing 11, an image forming section 12, a sheet supplying section 13, and the sheet processing device 2A.

The two-dot chain line in FIG. 1 represents an original reading device 16, which is configured to read information on an original. If the image forming apparatus 10A includes the original reading device 16, the image forming apparatus 10A serves as a multifunction machine having not only a printer function but also functions including copying and scanning.

As illustrated in FIG. 1 and others, the image forming apparatus 10A is installed on an installation surface 100.

The housing 11 is obtained by assembling materials such as frames, plates, and exterior members into a structure having an external shape and an internal construction that are predetermined.

Inside the housing 11 are provided not only the image forming section 12 and the sheet supplying section 13 but also a sheet transport path 14 and so forth. Inside the housing 11 are also provided a controller, a drive unit, a power source, and so forth (not illustrated).

The housing 11 has an external shape a part of which serves as an output accommodation part 15.

The output accommodation part 15 is a space that is provided in an upper part of the image forming apparatus 10A and where the housing 11 is recessed rearward from the front side. The output accommodation part 15 includes a lateral face 15a, which extends rearward from the front side; and a rear face 15b, which is located on the rear side (see FIGS. 1 and 2).

The housing 11 is provided on the outside thereof with an operation display and so forth (not illustrated).

The image forming section 12 is configured to form an image on a sheet 19 through a predetermined image forming scheme.

The image forming section 12 according to the first exemplary embodiment is configured as an imaging device that employs an image forming scheme based on electrophotography or the like.

The imaging device in the present exemplary embodiment includes devices (not illustrated) such as a photoconductor, a charging device, an image exposure device, a developing device, a transfer device, and a fixing device. The imaging device is not limited to a device configured to form a monochrome image and may be a device configured to form a multicolor image.

The image exposure device is configured to form an electrostatic latent image by applying light generated in correspondence with image information to the photoconductor that is precharged. Image information is inputted from, for example, an external device connected to the image forming apparatus 10A or from the original reading device 16.

Image information refers to visual information such as text, figures, and photographs and is reproducible by the image forming section 12.

The sheet supplying section 13 is configured to accommodate predetermined sheets 19 and to supply the sheets 19 toward the image forming section 12.

The sheet supplying section 13 includes an accommodation member, a delivery device, and so forth. The accommodation member is a structure that accommodates a stack of sheets 19. The delivery device is configured to deliver the sheets 19 in the accommodation member one by one toward the sheet transport path 14.

The sheet supplying section 13 according to the first exemplary embodiment includes two sheet supplying units 13A and 13B. The two sheet supplying units 13A and 13B include respective accommodation members so as to accommodate sheets 19 of different sizes or kinds or in different orientations between the two.

The sheet 19 is a sheet-type medium of predetermined dimensions that is transportable along the sheet transport path 14 and on which an image is formable.

The sheet transport path 14 is configured to transport the sheet 19 to a predetermined destination in the housing 11.

The sheet transport path 14 is defined by predetermined numbers of elements including transporting-roll pairs and sheet-guiding members.

The sheet transport path 14 is configured on the basis of a center-registration transport scheme (a transport scheme with reference to the center). In the center-registration transport scheme, the sheet is guided and transported such that the widthwise center of the sheet in the orientation for transport coincides with the widthwise center of the sheet transport path.

The sheet transport path 14 according to the first exemplary embodiment extends from the sheet supplying section 13, passes through the image forming section 12, and reaches a sheet outputting section.

The sheet outputting section includes a part configured to output the sheet 19 to the sheet processing device 2A, and a normal output port 17. The output port 17 is provided at a predetermined location of the lateral face 15a of the output accommodation part 15.

The sheet transport path 14 according to the first exemplary embodiment branches into two output paths 14b and 14c at a position before the normal output port 17. At the branching point between the output paths 14b and 14c is provided a directing member 14e, with which the destination of sheet transport is changed between the output paths 14b and 14c.

The output path 14b is connected at the terminal end thereof to an introduction port 23, which is provided in the sheet processing device 2A and will be described below (see FIG. 3).

The output path 14c is connected at the terminal end thereof to the output port 17 (see FIGS. 1 and 3).

### (2) Sheet Processing Device

The sheet processing device 2A is configured to perform a post-processing operation, such as a binding operation, on sheets 19.

The sheet processing device 2A according to the first exemplary embodiment is configured to perform at least a binding operation on sheets 19 outputted from the image forming section 12.

The sheet processing device 2A is installed in a lower space of the output accommodation part 15 of the image forming apparatus 10A (see FIG. 1 and others).

The sheet processing device 2A has a depthwise length Lz2 smaller than a depthwise length Lz1 of the image forming apparatus 10A (see FIG. 2). The depthwise length Lz2 is substantially equal to the depthwise length of the output accommodation part 15. That is, the sheet processing device 2A is a compact device just accommodatable in the output accommodation part 15.

The sheet processing device 2A includes a housing 20, a collecting part 3, a lower-end receiver 4, a binder 5, and a mover-supporter 6 (see FIG. 3 and others).

The housing 20 is obtained by assembling materials such as frames, plates, and exterior members into a structure having an external shape and an internal construction that are predetermined.

The housing 20 according to the first exemplary embodiment includes a base member 21 and a covering 22.

The base member 21 provides a base structure of the housing 20. The base member 21 has an outline that is shaped and sized in such a manner as to be attachable to the output accommodation part 15 of the housing 11.

The bottom of the base member 21 according to the first exemplary embodiment inclines upward from the left end toward the right side and thereafter extends substantially horizontally.

At the left end of the base member 21 is provided the introduction port 23, into which the sheet 19 is to be introduced (see FIG. 3). The introduction port 23 is connected to the output path 14b.

The covering 22 covers at least the top of the base member 21.

The top face of the covering 22 according to the first exemplary embodiment serves as an accommodation part 22a, which is capable of accommodating the sheet 19. The accommodation part 22a is designed to accommodate the sheet 19 transported from the image forming section 12 along the output path 14c and outputted from the output port 17.

The covering 22 is provided with an extended supporting member 28, which is designed to support a portion of the sheet 19 accommodated by the accommodation part 22a.

The covering 22 is capable of accommodating the sheet 19 having an image formed thereon without introducing the sheet 19 into the sheet processing device 2A.

Inside the housing 20 are provided the collecting part 3, the lower-end receiver 4, the binder 5, the mover-supporter 6, and so forth.

Inside the housing 20 are further provided a sheet introduction path 24, and other relevant elements including a drive unit and a controller (not illustrated).

The sheet introduction path 24 is configured such that the sheet 19 introduced into the introduction port 23 is transported to the collecting part 3.

The sheet introduction path 24 according to the first exemplary embodiment extends from the introduction port 23, passes through an upper part of the housing 20, and reaches the collecting part 3.

The sheet introduction path 24 is defined by predetermined numbers of elements including transporting-roll pairs 24a, 24b, and 24c and sheet guiding members 24e and 24f.

The transporting-roll pairs 24a, 24b, and 24c are each constituted by a driving roll that is driven to rotate, and a follower roll that is in contact with the driving roll and rotates by following the driving roll.

The sheet guiding member 24e guides the sheet 19 from the introduction port 23 and through the transporting-roll pairs 24a, 24b, and 24c in that order. The sheet guiding member 24f receives the sheet 19 exiting from the last transporting-roll pair 24c and guides the sheet 19 downward.

The housing 20 is further provided with an accommodation tray 25, which extends from the inside of the housing 20 to the outside.

The accommodation tray 25 is designed to accommodate a sheet batch, which is a set of sheets 19, after a binding operation is performed thereon. The accommodation tray 25 has an accommodation surface 25a, which inclines upward from the left side toward the right side.

The accommodation tray 25 according to the first exemplary embodiment is configured to be moved up and down by an up-and-down movement mechanism 26. In other words, the accommodation tray 25 is displaceable up and down in correspondence with the volume of the sheet batch accommodated. Such a tray that is movable up and down is also called a stacker.

The accommodation tray 25 includes an extension tray 27, which is to be pulled out of the body of the accommodation tray 25 so as to provide an extended accommodation surface. The extension tray 27 is retractable into the body of the accommodation tray 25 when not in use.

The collecting part 3 is configured to carry in and collect sheets 19 each introduced from the sheet introduction path 24.

The collecting part 3 according to the first exemplary embodiment includes a stacking plate 31, a lateral-end aligner 32, a first paddle 33, a second paddle 34, and a delivery roll 35. The collecting part 3 actually includes the lower-end receiver 4.

The stacking plate 31 is a planar member having a stacking surface 31a, on which sheets 19 are to be stacked and collected.

The stacking plate 31 is located below the terminal end of the sheet introduction path 24 and between the accommodation tray 25 and the binder 5. The stacking plate 31 is a substantially rectangular planar member that is oblong in the rearward direction +Z (see FIG. 4).

The stacking plate 31 is inclined such that an end 31c of the stacking surface 31a that faces the binder 5 is at the lower position. Thus, on the stacking plate 31, the sheet 19 introduced from the sheet introduction path 24 tends to move under its own weight along the inclined stacking surface 31a.

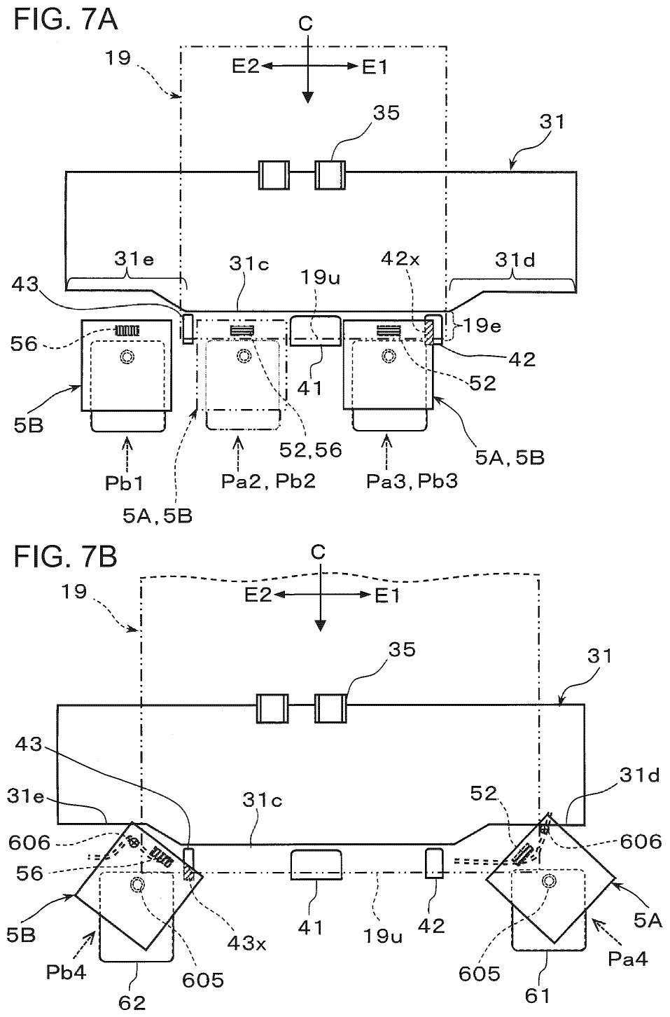

The stacking plate 31 has indentations 31d and 31e at the end 31c thereof (see FIG. 7). The indentations 31d and 31e are provided by cutting corners of the stacking plate 31 that are on two respective sides of the end 31c in the long-side direction. The indentations 31d and 31e are each used as a work space for the binder 5 to perform corner oblique binding to be described separately below.

In the first exemplary embodiment, a portion of the accommodation tray 25 that is adjacent to the stacking plate 31 is also used as a portion of the collecting part 3. Specifically, the portion of the accommodation tray 25 is used as a member that receives a portion of a sheet 19 that is too long to accommodate by the stacking plate 31.

The lateral-end aligner 32 is configured to align lateral ends 19c and 19d, in a carry-in orientation, of sheets 19 that are stacked on the stacking plate 31.

The lateral-end aligner 32 according to the first exemplary embodiment includes a pair of aligning plates 32F and 32R (see FIG. 4). The aligning plate 32F is located on the front side of the image forming apparatus 10A and the sheet processing device 2A. The aligning plate 32R is located on the rear side of the image forming apparatus 10A and the sheet processing device 2A.

The aligning plates 32F and 32R are each movable by a predetermined distance in widthwise directions E1 and E2. The widthwise directions E1 and E2 are orthogonal to a carry-in direction C, in which the sheet 19 is to be carried.

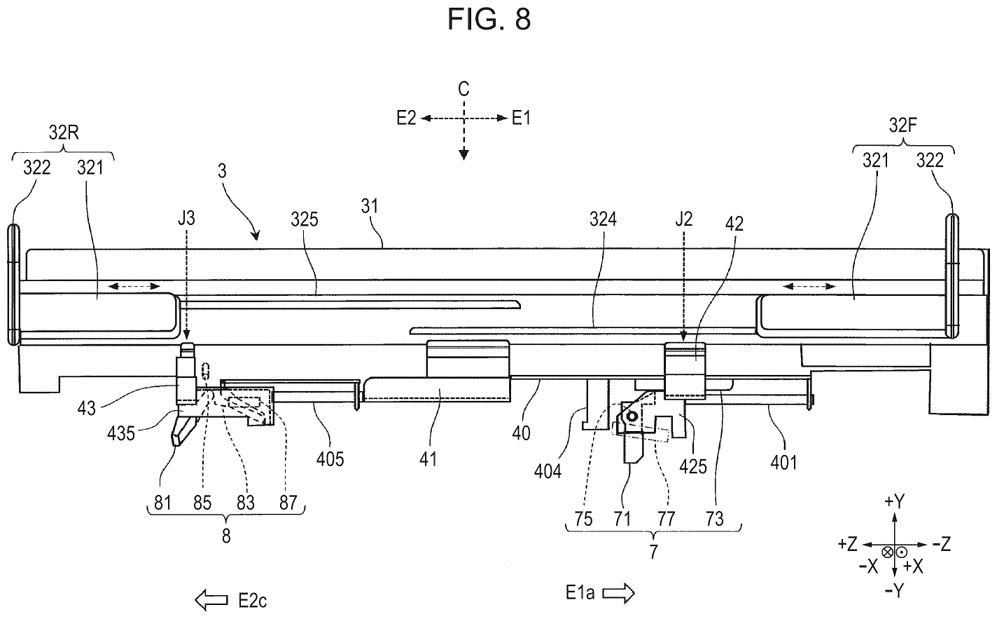

The aligning plates 32F and 32R each include a bottom plate 321 and a lateral wall 322 (see FIG. 8). The lateral wall 322 stands substantially perpendicularly from one end of the bottom plate 321. The bottom plates 321 are movable while being guided along respective slide grooves 324 and 325, which are provided in the stacking plate 31 and extend in the widthwise directions E1 and E2.

The aligning plates 32F and 32R are movable by a driving mechanism (not illustrated) provided on the lower surface (back side) of the stacking plate 31. The aligning plates 32F and 32R are movable toward and away from each other in the widthwise directions E1 and E2.

In an aligning operation, the aligning plates 32F and 32R move in such a manner as to sandwich the sheets 19 on the stacking plate 31 from the lateral sides. Thus, the positions of the lateral ends 19c and 19d of the sheets 19 in the widthwise directions E1 and E2 on the stacking plate 31 are adjusted, whereby the sheets 19 are aligned.

The first paddle 33 is a rotary paddle configured to carry the sheet 19 dropped onto the stacking plate 31, toward a side of the stacking plate 31 that faces the lower-end receiver 4.

The first paddle 33 is located above the stacking plate 31 and in the gap between the sheet guiding member 24f and the covering 22. The first paddle 33 includes a movable paddle part 33a and a driving-and-supporting part 33b.

The movable paddle part 33a is a rotatable body including multiple elastic plates arranged at intervals. The movable paddle part 33a is rotatable as represented by an arrow, and is also movable up and down about the driving-and-supporting part 33b.

The driving-and-supporting part 33b serves as a pivot for the movable paddle part 33a and is configured to transmit a rotational driving force to the movable paddle part 33a through a transmission belt or the like.

When no sheet 19 is to be carried in, the movable paddle part 33a of the first paddle 33 stands by at a position above the sheet guiding member 24f. Therefore, the movable paddle part 33a of the first paddle 33 does not hinder the introduction of the sheet 19 onto the stacking plate 31.

When a sheet 19 is introduced onto the stacking plate 31, the movable paddle part 33a of the first paddle 33 is lowered to approach the sheet 19. Thus, the movable paddle part 33a of the first paddle 33 comes into contact with the sheet 19 on the stacking plate 31 at the rotating elastic plates thereof.

Consequently, the first paddle 33 carries the sheet 19 on the stacking plate 31 toward the lower-end receiver 4.

The second paddle 34 is a rotary paddle configured to cause the sheet 19 carried along the stacking plate 31 by the first paddle 33 to further advance toward the lower-end receiver 4.

The second paddle 34 is located above the lower end (the end 31c, or the left end) of the stacking plate 31. The second paddle 34 is a rotatable body including multiple elastic plates arranged at intervals and is rotatable as represented by an arrow.

The second paddle 34 is configured to come into contact with the sheet 19 on the stacking plate 31 at the rotating elastic plates thereof.

Thus, the second paddle 34 further carries the sheet 19 into the lower-end receiver 4.

The delivery roll 35 is configured to deliver a sheet batch, or a set of sheets 19, having undergone a binding operation from the stacking plate 31 to the accommodation tray 25.

The delivery roll 35 is positioned such that a portion thereof slightly projects upward relative to the stacking surface 31a at the upper end (right end) of the stacking plate 31.

When the sheet batch becomes ready to be outputted, the delivery roll 35 rotates as represented by an arrow for a predetermined time period. Thus, the delivery roll 35 delivers the sheet batch from the stacking plate 31 to the accommodation tray 25.

The lower-end receiver 4 is an element with which lower ends 19u of multiple sheets 19 collected to the collecting part 3 are to be brought into contact.

The lower ends 19u of the sheets 19 are ends of the sheets 19 that are on the downstream side in the carry-in direction C.

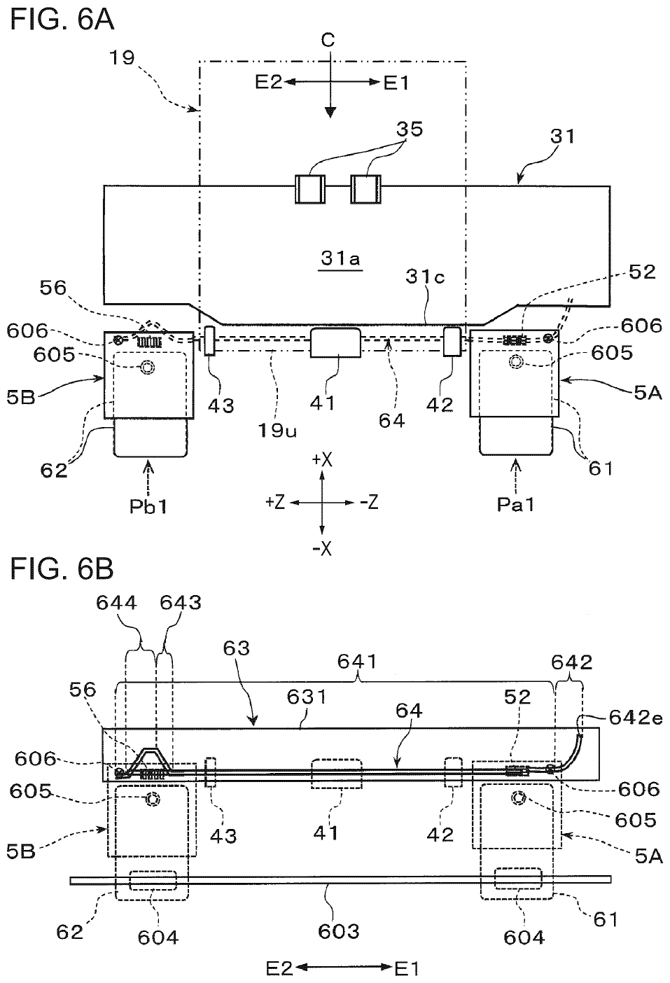

In the first exemplary embodiment, the lower-end receiver 4 includes three lower-end-receiving members 41, 42, and 43 (see FIGS. 4 and 6).

The lower-end-receiving members 41, 42, and 43 are arranged separately from one another at three respective normal positions where the lower-end-receiving members 41, 42, and 43 are supposed to come into contact with a lower end 19u of a sheet 19S. The sheet 19S refers to a sheet 19 having a smallest possible width Ws. The smallest possible width Ws refers to a width W of the sheet 19 that is the smallest possible in an orientation at the time of carry in. The three normal positions are denoted as normal positions J1, J2, and J3 (see FIG. 4).

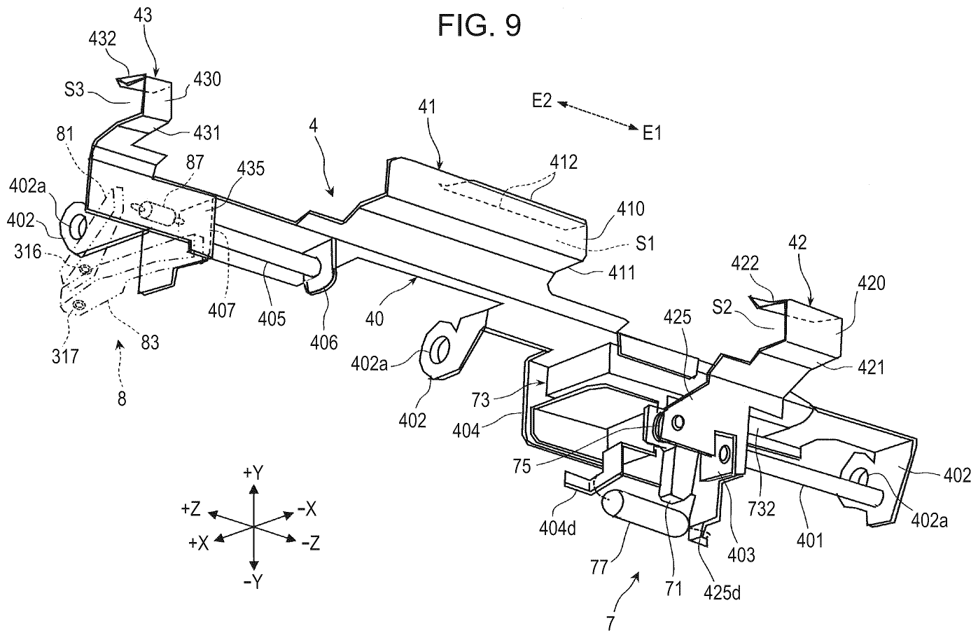

The lower-end-receiving members 41, 42, and 43 are provided on a body 40 (see FIG. 9).

The lower-end receiver 4 is oriented such that the lower-end-receiving members 41, 42, and 43 face the lower end of the stacking plate 31.

The body 40 is a substantially rectangular planar member that is oblong in the widthwise direction E (see FIG. 9). The body 40 includes multiple attaching portions 402, at which the body 40 is attached to the lower surface of the stacking plate 31.

As illustrated in FIG. 9, the attaching portions 402 have respective holes 402a, in which a supporting shaft (not illustrated) provided on the lower surface of the stacking plate 31 is rotatably fitted. Thus, the lower-end receiver 4 is able to swing downward about the supporting shaft and is movable to a retracted position when necessary.

The lower-end-receiving member 41 is supposed to receive a substantially central portion of the lower end 19u of the sheet 19S having the smallest possible width Ws. The lower-end-receiving member 41 is hereinafter also referred to as center lower-end-receiving member 41.

The center lower-end-receiving member 41 is shaped as a structure including a contact wall portion 410, a bottom portion 411, and a top portion 412. The bottom portion 411 and the top portion 412 provide respective surfaces extending from the upper end and the lower end, respectively, of the contact wall portion 410 and substantially opposite each other.

The center lower-end-receiving member 41 has an accommodation space S1, which is defined by the contact wall portion 410, the bottom portion 411, and the top portion 412 (see FIG. 9). The accommodation space S1 is provided to accommodate and hold lower portions, including the lower ends 19u, of multiple sheets 19S. The above description also applies to accommodation spaces S2 and S3 to be described below.

The center lower-end-receiving member 41 is fixed to the body 40.

The lower-end-receiving member 42 is supposed to receive a portion of the lower end 19u of the sheet 19S having the smallest possible width Ws that is near the front end of the sheet 19S. The lower-end-receiving member 42 is hereinafter also referred to as front lower-end-receiving member 42.

The front lower-end-receiving member 42 is shaped as a structure including a contact wall portion 420, a bottom portion 421, and a top portion 422. The front lower-end-receiving member 42 has the accommodation space S2 defined by the contact wall portion 420, the bottom portion 421, and the top portion 422 (see FIG. 9).

The lower-end-receiving member 43 is supposed to receive a portion of the lower end 19u of the sheet 19S having the smallest possible width Ws that is near the rear end of the sheet 19S. The lower-end-receiving member 43 is hereinafter also referred to as rear lower-end-receiving member 43.

The rear lower-end-receiving member 43 is shaped as a structure including a contact wall portion 430, a bottom portion 431, and a top portion 432. The rear lower-end-receiving member 43 has the accommodation space S3 defined by the contact wall portion 430, the bottom portion 431, and the top portion 432 (see FIG. 9).

The binder 5 is configured to bind a part of an end portion 19e of a sheet batch obtained as a set of sheets 19 collected to the collecting part 3.

The end portion 19e of a sheet batch obtained as a set of sheets 19 refers to a portion of the sheet batch that is at the downstream end in the carry-in direction C in which each of the sheets 19 is carried (see FIG. 7A). The end portion 19e spreads from the lower ends 19u of the sheets 19 and inward of the sheets 19 by a small length.

According to the first exemplary embodiment, two binders (5A and 5B) are employed as the binder 5. The two binders (5A and 5B) are of different kinds in terms of binding operation, as to be described below.

One binder 5 is a stapling binder 5A, which is configured to perform a binding operation in a stapling manner.

The stapling binder 5A includes a body 51 and a pair of stapling parts 52 and 53.

The body 51 is an enclosure formed of exterior members. The body 51 houses a staple feeder 54, a drive unit, and so forth.

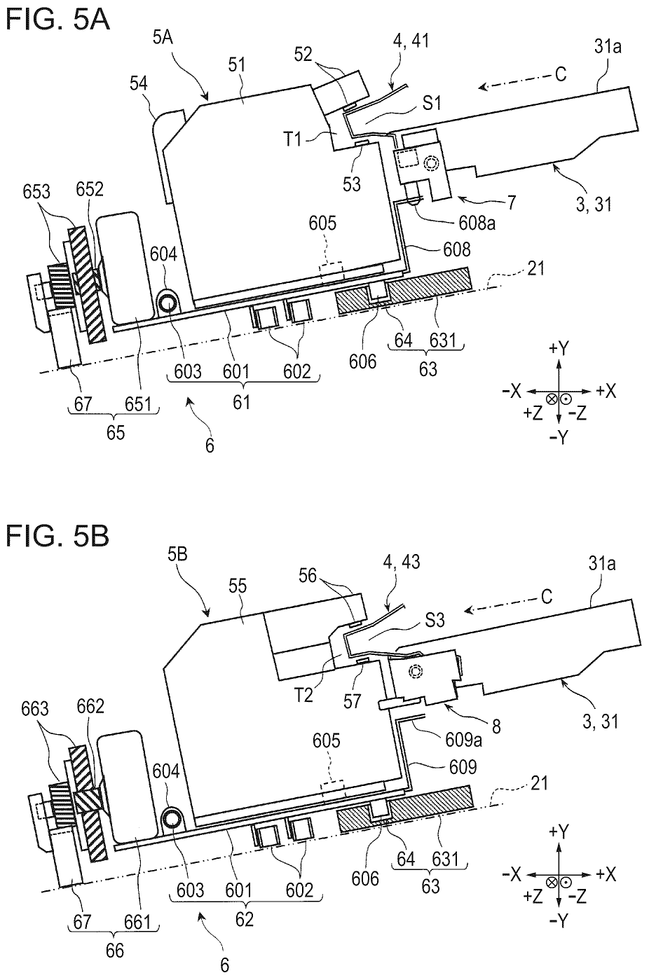

The pair of stapling parts 52 and 53 are configured to perform a binding operation in a stapling manner. The pair of stapling parts 52 and 53 are arranged with a gap T1 in between so that the lower-end-receiving members 41, 42, and 43 are allowed to pass through (see FIG. 5A).

The stapling part 52 is movable in such a manner as to dispense a staple. In the binding operation, the stapling part 52 is lowered toward the stapling part 53 to insert a staple into a part of the sheet batch.

The stapling part 53 is fixed so as to receive and bend the staple. In the binding operation, the stapling part 53 receives and bends the ends of the staple dispensed from the stapling part 52 and penetrating through the part of the sheet batch.

The other binder 5 is a stapleless binder 5B, which is configured to perform a binding operation in a stapleless manner. The binding operation in a stapleless manner refers to a binding operation in which no staple is used.

The stapleless binder 5B includes a body 55 and a pair of stapleless binding parts 56 and 57.

The body 55 is an enclosure formed of exterior members. The body 55 houses a drive unit and so forth.

The pair of stapleless binding parts 56 and 57 are configured to perform a binding operation by nipping the sheet batch between an upper binding tooth and a lower binding tooth thereof and thus deforming the sheet batch. The pair of stapleless binding parts 56 and 57 are arranged with a gap T2 in between so that the lower-end-receiving members 41, 42, and 43 are allowed to pass through (see FIG. 5B).

The stapleless binding part 56 is a movable part having the upper binding tooth, which has a ragged shape

In the binding operation, the stapleless binding part 56 moves toward the stapleless binding part 57. Furthermore, the stapleless binding part 56 comes into contact at the upper binding tooth thereof with a part of the end portion 19e of the sheet batch, and further moves toward the stapleless binding part 57.

The stapleless binding part 57 is a fixed part having the lower binding tooth, which has a ragged shape.

In the binding operation, the stapleless binding part 57 receives and holds at the lower binding tooth thereof the part of the end portion 19e of the sheet batch that is pushed by the upper binding tooth.

The pair of stapleless binding parts 56 and 57 bind the sheet batch by deforming the part of the end portion 19e of the sheet batch while nipping the part between the upper binding tooth and the lower binding tooth with a high pressure.

The mover-supporter 6 is configured to support the binder 5 in such a manner as to move the binder 5 around the end portion 19e of the sheet batch.

The mover-supporter 6 according to the first exemplary embodiment supports the stapling binder 5A and the stapleless binder 5B while allowing the two to move.

The mover-supporter 6 moves the stapling binder 5A and the stapleless binder 5B in the rearward direction, that is, from the front side toward the rear side.

On the mover-supporter 6, the stapling binder 5A is located on the front side, and the stapleless binder 5B is located on the rear side.

The mover-supporter 6 causes the stapling binder 5A and the stapleless binder 5B to move along the lower-end receiver 4 without interfering with the lower-end receiver 4.

The binders 5A and 5B are individually caused to move past at least one of the lower-end-receiving member 41, the lower-end-receiving member 42, and the lower-end-receiving member 43 of the lower-end receiver 4.

In this movement, the lower-end receiver 4 is made to pass through the gap T1 provided in the stapling binder 5A or the gap T2 provided in the stapleless binder 5B (see FIGS. 5A and 5B).

The mover-supporter 6 supports the binder 5 and is configured to stop the binder 5 at multiple stop positions including multiple binding positions.

The mover-supporter 6 according to the first exemplary embodiment supports the stapling binder 5A and the stapleless binder 5B and are configured to stop the stapling binder 5A and the stapleless binder 5B individually at respective stop positions.

The stop positions include a standby position Pa1, which is defined for the stapling binder 5A; and a standby position Pb1, which is defined for the stapleless binder 5B (see FIGS. 4, 6A, and 6B).

The standby position refers to a position taken when no binding operation is necessary or after a binding operation is complete.

The stop positions further include dual-flat-binding positions Pa2 and Pa3, which are defined for the stapling binder 5A (see FIG. 7A). The stop positions further include dual-flat-binding positions Pb2 and Pb3, which are defined for the stapleless binder 5B (see FIG. 7A).

Dual flat binding refers to a way of binding in which the sheet batch is bound at two positions in the end portion 19e such that the resulting stitches extend parallel to the lower end 19u.

The dual-flat-binding positions Pa2 and Pb2 are each regarded as a first dual-flat-binding position and are defined between the rear lower-end-receiving member 43 and the center lower-end-receiving member 41, in principle. The dual-flat-binding positions Pa3 and Pb3 are each regarded as a second dual-flat-binding position and are defined between the center lower-end-receiving member 41 and the front lower-end-receiving member 42, in principle.

The stop positions further include a corner-oblique-binding position Pa4, which is defined for the stapling binder 5A (see FIG. 7B). The stop positions further include a corner-oblique-binding position Pb4, which is defined for the stapleless binder 5B (see FIG. 7B).

Corner oblique binding refers to a way of binding in which the sheet batch is bound at a corner of the end portion 19e such that the resulting stitch extends obliquely relative to the lower end 19u.

At the corner-oblique-binding position Pa4, the stapling binder 5A obliquely faces a corner of the end portion 19e that is on the front side relative to the front lower-end-receiving member 42. At the corner-oblique-binding position Pb4, the stapleless binder 5B obliquely faces a corner of the end portion 19e that is on the rear side relative to the rear lower-end-receiving member 43.

As illustrated in FIGS. 5A, 5B, 6A, 6B, and others, the mover-supporter 6 includes carriers 61 and 62, an orientation guide plate 63, and moving devices 65 and 66.

The carrier 61 and the carrier 62 are movable bases configured to travel while carrying the stapling binder 5A and the stapleless binder 5B, respectively.

The carriers 61 and 62 each include a planar body 601 and wheels (rollers) 602. The wheels 602 are provided on the lower surface of the body 601. The carriers 61 and 62 travel with the wheels 602 rotating in the widthwise direction E on a traveling surface provided as a portion of the base member 21 of the housing 20.

The carriers 61 and 62 are guided along a movement guide bar 603 while moving. The carriers 61 and 62 each include a portion 604, in which a through-hole is provided for the movement guide bar 603 to pass through.

The movement guide bar 603 extends linearly in the widthwise direction E and is fixed at the two ends thereof to the base member 21 of the housing 20. Thus, the carriers 61 and 62 are linearly movable in the widthwise directions E1 and E2.

The stapling binder 5A and the stapleless binder 5B are rotatably attached to the bodies 601 of the respective carriers 61 and 62.

The stapling binder 5A and the stapleless binder 5B attached to the carriers 61 and 62 are rotatably fitted on respective supporting shafts 605. Thus, the stapling binder 5A and the stapleless binder 5B are rotatable about the respective supporting shafts 605 on the respective carriers 61 and 62.

The orientation guide plate 63 is a planar member designed to change the orientation of the stapling binder 5A and the stapleless binder 5B while guiding the two.

Herein, the orientation refers to the position (attitude) of each of the stapling binder 5A and the stapleless binder 5B relative to the stacking plate 31.

In other words, the orientation refers to the orientation of the stapling parts 52 and 53 of the stapling binder 5A relative to the stacking plate 31 and to the end portion 19e of the sheet batch. The orientation also refers to the orientation of the stapleless binding parts 56 and 57 of the stapleless binder 5B relative to the stacking plate 31 and to the end portion 19e of the sheet batch.

The orientation guide plate 63 is designed as a supporting plate 631, which has a guide groove 64 (see FIGS. 5A, 5B, and 6B).

The supporting plate 631 is a substantially rectangular plate that is oblong in the widthwise direction E. The supporting plate 631 is fixed to the bottom surface of the base member 21 of the housing 20.

The guide groove 64 includes a linear guide portion 641, a first curved guide portion 642, a second curved guide portion 643 and a third curved guide portion 644.

The stapling binder 5A and the stapleless binder 5B are guided at respective guided shafts 606, which are fitted in the guide groove 64 (see FIGS. 5A, 5B, 6A, and 6B).

The guided shafts 606 project from the lower surfaces of the stapling binder 5A and the stapleless binder 5B toward the guide groove 64. The guided shafts 606 are each located closer to the stacking plate 31 than a corresponding one of the supporting shafts 605 is and near a corner of a corresponding one of the carriers 61 and 62.

The linear guide portion 641 is a guide groove that extends linearly parallel to the end 31c of the stacking plate 31 or in the widthwise direction E. The linear guide portion 641 is located in a central area of the supporting plate 631 in the long-side direction.

The linear guide portion 641 is designed to guide the stapling binder 5A to the dual-flat-binding positions Pa2 and Pa3 and determine the orientation of the stapling binder 5A there. The linear guide portion 641 is also designed to guide the stapling binder 5A to the standby position Pa1 and determine the orientation of the stapling binder 5A there. The linear guide portion 641 is also designed to guide the stapleless binder 5B to the dual-flat-binding positions Pb2 and Pb3 and determine the orientation of the stapleless binder 5B there.

The stapling binder 5A and the stapleless binder 5B when in the linear guide portion 641 are each oriented substantially parallel to the lower ends 19u of the sheets 19 on the stacking plate 31. The orientation in such a situation is determined and maintained in relation to the positions of the supporting shaft 605 and the guided shaft 606.

The first curved guide portion 642 is a guide groove that curves from the front end of the linear guide portion 641 toward the stacking plate 31.

The first curved guide portion 642 is located in a front-end area of the supporting plate 631 in the long-side direction.

The first curved guide portion 642 is designed to guide the stapling binder 5A to the corner-oblique-binding position Pa4 and determine the orientation of the stapling binder 5A there. The first curved guide portion 642 is also designed to guide the stapling binder 5A to a staple refilling position, which is defined beyond the corner-oblique-binding position Pa4.

The stapling binder 5A when in the first curved guide portion 642 is oriented obliquely to the corresponding corner of the end portion 19e of the sheet batch on the stacking plate 31. The corner of the end portion 19e of the sheet batch in such a situation is the front corner. The orientation in such a situation is determined and maintained in relation to the positions of the supporting shaft 605 and the guided shaft 606.

The second curved guide portion 643 is a guide groove that curves from a position before the rear end of the linear guide portion 641 toward the stacking plate 31.

The second curved guide portion 643 is located in a rear-end area of the supporting plate 631 in the long-side direction. The second curved guide portion 643 is provided as a branch groove extending from a position before the rear end of the linear guide portion 641.

The second curved guide portion 643 is designed to guide the stapleless binder 5B to the corner-oblique-binding position Pb4 and determine the orientation of the stapleless binder 5B there.

The stapleless binder 5B when in the second curved guide portion 643 is oriented obliquely to the corresponding corner of the end portion 19e of the sheet batch on the stacking plate 31. The corner of the end portion 19e of the sheet batch in such a situation is the rear corner. The orientation in such a situation is determined and maintained in relation to the positions of the supporting shaft 605 and the guided shaft 606.

The third curved guide portion 644 is a guide groove that curves from the terminal end of the second curved guide portion 643 back to the linear guide portion 641.

The third curved guide portion 644 is continuous with the terminal end of the second curved guide portion 643 in the rear-end area of the supporting plate 631 in the long-side direction. The second curved guide portion 643 is provided as a branch groove extending from a position before the rear end of the linear guide portion 641.

The third curved guide portion 644 is designed to guide the stapleless binder 5B to the standby position Pb1 and determine the orientation of the stapleless binder 5B there.

The stapleless binder 5B when in the third curved guide portion 644 is oriented substantially parallel to the lower ends 19u of the sheets 19 on the stacking plate 31. The orientation in such a situation is determined and maintained in relation to the positions of the supporting shaft 605 and the guided shaft 606.

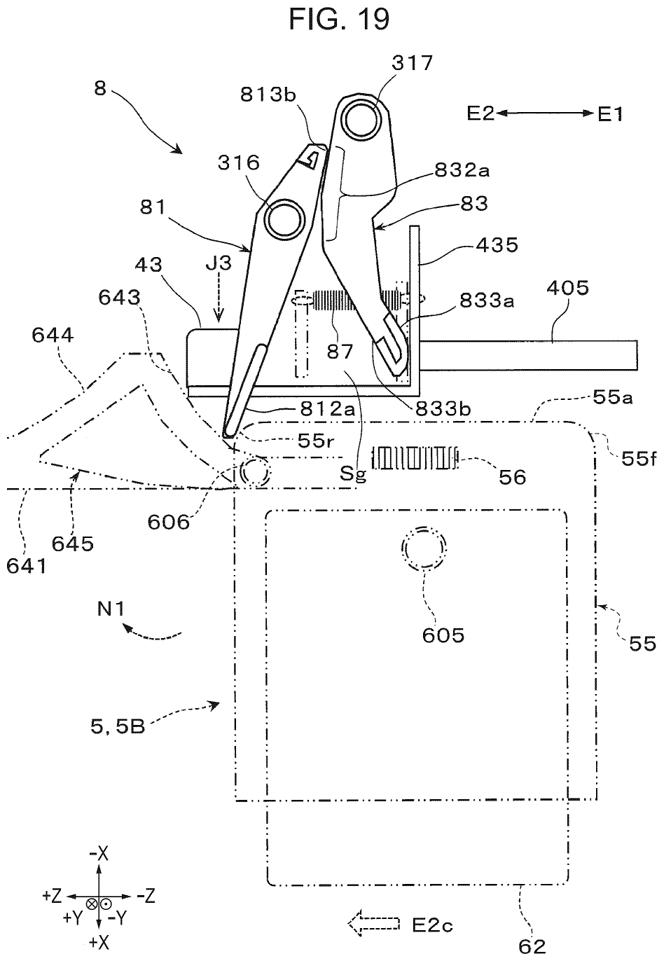

The guide groove 64 according to the first exemplary embodiment is provided with a displacement guide 645, exemplified in FIG. 19.

The displacement guide 645 is displaceable in an area defined by the linear guide portion 641, the second curved guide portion 643, and the third curved guide portion 644. The displacement guide 645 according to the first exemplary embodiment has a substantially triangular flat shape defined by three curved sides.

In normal times, the displacement guide 645 is at a normal position, where the second curved guide portion 643 and the third curved guide portion 644 of the guide groove 64 are exposed. The displacement guide 645 at the normal position is elastically urged to stay at the normal position by an urging member such as a spring.

The displacement guide 645 is displaced when the stapleless binder 5B moves from the standby position Pb1 to the dual-flat-binding position Pb2. With this displacement, the linear guide portion 641 appears on the +X side relative to the second curved guide portion 643 and the third curved guide portion 644.

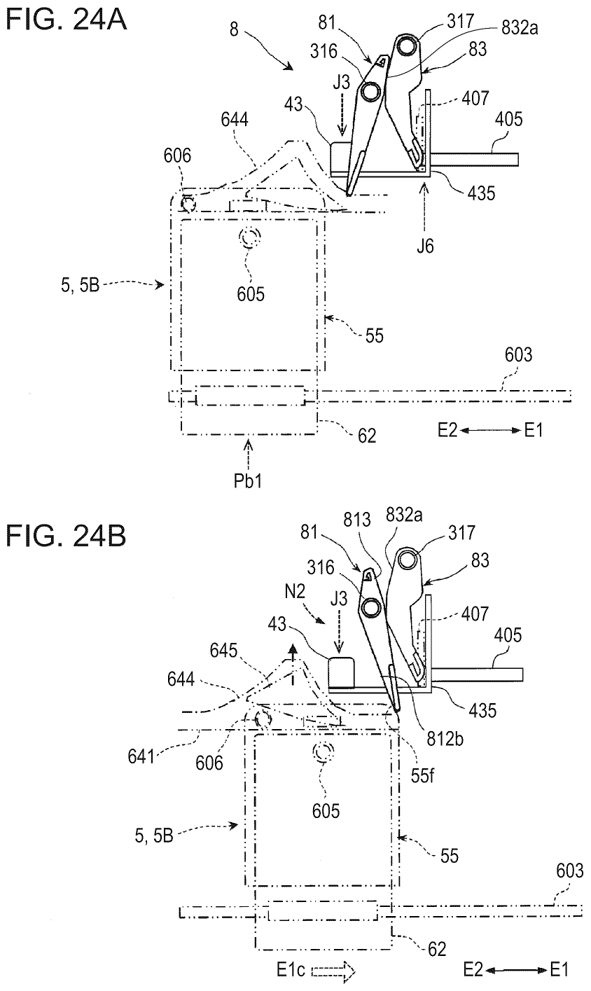

With the movement of the stapleless binder 5B, the displacement guide 645 is displaced from the normal position (see FIG. 24B). The displacement guide 645 is displaced by the guided shaft 606 of the stapleless binder 5B entering a space provided on the +X side of the displacement guide 645 and pushing the displacement guide 645.

The moving devices 65 and 66 are configured to move and stop the carriers 61 and 62 and consequently the stapling binder 5A and the stapleless binder 5B, respectively.

The moving device 65 includes a drive source 651 and a rack 67 (see FIG. 5A). The moving device 65 is similar to a rack-and-pinion mechanism.

The drive source 651 includes a motor, a driving gear 652, and a double gear 653. The driving gear 652 is attached to the output shaft of the motor. The double gear 653 includes a large-diameter gear and a small-diameter gear, and is rotatable with the large-diameter gear meshing with the driving gear 652. The drive source 651 is provided on the carrier 61.

The rack 67 has gear teeth at the upper surface thereof and serves as a gear that extends linearly in the widthwise direction E. The rack 67 is in mesh with the small-diameter gear of the double gear 653. The rack 67 is fixed to the base member 21 of the housing 20.

In the moving device 65, with the activation of the drive source 651, the small-diameter gear of the double gear 653 that is in mesh with the rack 67 rotates.

Thus, the moving device 65 causes the carrier 61 carrying the drive source 651 to move in a predetermined direction along the movement guide bar 603.

The moving device 66 includes a drive source 661 and the rack 67 (see FIG. 5B). As with the moving device 65, the moving device 66 is similar to a rack-and-pinion mechanism.

The drive source 661 includes a motor, a driving gear 662, and a double gear 663. The motor, the driving gear 662, and the double gear 663 are the same as the motor, the driving gear 652, and the double gear 653 of the drive source 651. The drive source 661 is provided on the carrier 62.

The rack 67 is shared with the moving device 65.

In the moving device 66, with the activation of the drive source 661, the small-diameter gear of the double gear 663 that is in mesh with the rack 67 rotates.

Thus, the moving device 66 causes the carrier 62 carrying the drive source 661 to move in a predetermined direction along the movement guide bar 603.

### (3) Basic Operation of Sheet Processing Device

The sheet processing device 2A basically operates as follows.

When it is time to use the sheet processing device 2A, a sheet 19 having undergone image formation and outputted from the image forming apparatus 10A is introduced into the sheet processing device 2A through the introduction port 23.

In the sheet processing device 2A, the introduced sheet 19 is transported along the sheet introduction path 24 through the inside of the housing 20 toward the collecting part 3.

Then, the sheet 19 is delivered from the sheet introduction path 24 and falls onto the inclined stacking surface 31a of the stacking plate 31. If the sheet 19 is too long for the stacking plate 31, the sheet 19 is placed over the stacking plate 31 and a portion of the accommodation tray 25.

Subsequently, in the sheet processing device 2A, the movable paddle part 33a of the first paddle 33 that is rotating is lowered about the driving-and-supporting part 33b.

Meanwhile, the second paddle 34 also rotates as represented by the arrow.

Thus, the sheet 19 placed on the stacking plate 31 and so forth receives a transporting force generated by the first paddle 33 and the second paddle 34 and is carried toward the lower-end receiver 4. Then, the sheet 19 stops by coming into contact at the lower end 19u thereof with the three lower-end-receiving members 41, 42 and 43 of the lower-end receiver 4.

At the contact of the lower end 19u of the sheet 19 with the lower-end receiver 4, the movable paddle part 33a of the first paddle 33 moves upward and stands by. Every time a sheet 19 is collected onto the stacking plate 31, the aligning plates 32F and 32R of the lateral-end aligner 32 are activated.

Such an operation of collecting a sheet 19 is repeated for a number of times that corresponds to the number of sheets 19 to be bound.

Consequently, multiple sheets 19 are stacked on the stacking plate 31, whereby a sheet batch is obtained.

The lower ends 19u of the sheets 19 in the sheet batch are aligned by the lower-end receiver 4. The lateral ends 19c and 19d of the sheets 19 in the sheet batch are aligned by the lateral-end aligner 32.

Subsequently, if dual flat binding is to be performed with the use of the stapling binder 5A, the sheet processing device 2A operates as follows.

The mover-supporter 6 is activated to move the stapling binder 5A to the first dual-flat-binding position Pa2 (see FIG. 7A). In this case, the stapling binder 5A moves rearward from the standby position Pa1 toward the dual-flat-binding position Pa2. This movement is implemented with the activation of the moving device 65 of the mover-supporter 6 by a predetermined amount.

The stapling binder 5A thus moved faces the sheet batch in such an orientation that the long-side direction of the stapling parts 52 and 53 becomes substantially parallel to the end portion 19e of the sheet batch. The orientation of the stapling binder 5A at the dual-flat-binding position Pa2 is the same as at the standby position Pa1.

Then at the dual-flat-binding position Pa2, the stapling binder 5A performs a binding operation.

Thus, the sheet batch is bound flat with a staple at one position in the end portion 19e thereof.

Subsequently, the mover-supporter 6 is activated to move the stapling binder 5A to the second dual-flat-binding position Pa3 (see FIG. 7A). In this case, the stapling binder 5A moves frontward from the dual-flat-binding position Pa2 toward the dual-flat-binding position Pa3. This movement is also implemented with the activation of the moving device 65 of the mover-supporter 6 by a predetermined amount.

Then at the dual-flat-binding position Pa3, the stapling binder 5A performs a binding operation.

In this binding operation, the sheet batch is supposed to be bound flat with a staple at the second position in the end portion 19e thereof.

In the sheet processing device 2A, however, the binding operation to be performed at the second dual-flat-binding position Pa3 may involve Problem 1, which will be described separately below.

On the other hand, if corner oblique binding is to be performed with the use of the stapling binder 5A, the sheet processing device 2A operates as follows.

In this case, the mover-supporter 6 is activated to move the stapling binder 5A to the corner-oblique-binding position Pa4 (see FIG. 7B). In this case, the stapling binder 5A moves from the standby position Pa1 to the corner-oblique-binding position Pa4 while changing the orientation thereof. This movement is also implemented with the activation of the moving device 65 of the mover-supporter 6 by a predetermined amount.

The stapling binder 5A thus moved faces the front corner of the end portion 19e of the sheet batch in an oblique orientation.

Then at the corner-oblique-binding position Pa4, the stapling binder 5A performs a binding operation.

Thus, the sheet batch is bound obliquely with a staple at the corner of the end portion 19e thereof.

With the completion of the binding operation, the mover-supporter 6 is activated to move the stapling binder 5A to the standby position Pa1 (see FIG. 6A). This movement is also implemented with the activation of the moving device 65 of the mover-supporter 6 by a predetermined amount.

If dual flat binding is to be performed with the use of the stapleless binder 5B, the sheet processing device 2A operates as follows.

In this case, the mover-supporter 6 is activated to move the stapleless binder 5B to the first dual-flat-binding position Pb2 (see FIG. 7A). In this case, the stapleless binder 5B moves frontward from the standby position Pb1 toward the dual-flat-binding position Pb2. This movement is implemented with the activation of the moving device 66 of the mover-supporter 6 by a predetermined amount.

The stapleless binder 5B thus moved faces the sheet batch in such an orientation that the long-side direction of the stapleless binding parts 56 and 57 becomes substantially parallel to the end portion 19e of the sheet batch. The orientation of the stapleless binder 5B at the dual-flat-binding position Pb2 is the same as at the standby position Pb1.

Then at the dual-flat-binding position Pb2, the stapleless binder 5B performs a binding operation.

Thus, the sheet batch is bound flat with no staple at one position in the end portion 19e thereof.

Subsequently, the mover-supporter 6 is activated to move the stapleless binder 5B to the second dual-flat-binding position Pb3 (see FIG. 7A). In this case, the stapleless binder 5B moves frontward from the dual-flat-binding position Pb2 toward the dual-flat-binding position Pb3.

Then at the dual-flat-binding position Pb3, the stapleless binder 5B performs a binding operation.

In this binding operation, the sheet batch is supposed to be bound flat with no staple at the second position in the end portion 19e thereof.

In the sheet processing device 2A, however, the binding operation to be performed at the second dual-flat-binding position Pb3 may also involve Problem 1, which will be described separately below.

On the other hand, if corner oblique binding is to be performed with the use of the stapleless binder 5B, the sheet processing device 2A operates as follows.

In this case, the mover-supporter 6 is activated to move the stapleless binder 5B to the corner-oblique-binding position Pb4 (see FIG. 7B). In this case, the stapleless binder 5B moves from the dual-flat-binding position Pb2 to the corner-oblique-binding position Pb4 while changing the orientation thereof. This movement is also implemented with the activation of the moving device 66 of the mover-supporter 6 by a predetermined amount.

The stapleless binder 5B thus moved faces the rear corner of the end portion 19e of the sheet batch in an oblique orientation.

Then at the corner-oblique-binding position Pb4, the stapleless binder 5B performs a binding operation.

In this binding operation, the sheet batch is supposed to be bound obliquely with no staple at the rear corner of the end portion 19e thereof.

In the sheet processing device 2A, however, the binding operation to be performed at the corner-oblique-binding position Pb4 may involve Problem 2, which will be described separately below.

With the completion of corner oblique binding, the mover-supporter 6 is activated to move the stapleless binder 5B to the standby position Pb1 (see FIG. 6A). This movement is also implemented with the activation of the moving device 66 of the mover-supporter 6 by a predetermined amount. At the completion of corner oblique binding, the stapleless binder 5B may be moved back to the binding position Pb2.

In the sheet processing device 2A, after the completion of dual flat binding or corner oblique binding, the bound sheet batch is outputted to the accommodation tray 25.

Specifically, the bound sheet batch is delivered from the stacking plate 31 to the accommodation tray 25 with a transporting force generated by the delivery roll 35. The sheet batch thus delivered advances with upper ends 19t, opposite the lower ends 19u, of the sheets 19 leading.

### (4) Problems 1 and 2

The sheet processing device 2A may involve Problems 1 and 2, which are attributed to the arrangement of the three lower-end-receiving members 41, 42, and 43, as to be described below.

The lower-end-receiving members 41, 42, and 43 are set at three respective normal positions J1, J2, and J3 as described above (see FIG. 4).

Problem 1 relates to dual flat binding that is performed at the second position with the use of either of the stapling binder 5A and the stapleless binder 5B.

The binding operation to be performed with the stapling binder 5A or the stapleless binder 5B moving to the dual-flat-binding position Pa3 or Pb3 may be hindered by one of the lower-end-receiving members.

In the first exemplary embodiment, the one lower-end-receiving member is the front lower-end-receiving member 42. Specifically, in the lower-end-receiving member 42, a portion 42x, hatched with oblique lines in FIG. 7A, may be the hindrance.

Herein, the hindrance means that the portion 42x of the lower-end-receiving member 42 may hinder the movement of the binder 5 (5A or 5B) to the binding position. The portion 42x of the lower-end-receiving member 42 may also hinder the binding action of the binder 5 at the binding position.

Consequently, dual flat binding to be performed at the second position with the use of the stapling binder 5A or the stapleless binder 5B may be hindered by the front lower-end-receiving member 42. Such a situation is referred to as Problem 1.

Herein, the expression “the binder 5 (5A or 5B)” means that the binder 5 of interest is either of the two binders (5A and 5B). The two binders (5A and 5B) are the stapling binder 5A and the stapleless binder 5B.

Problem 2 relates to corner oblique binding that is performed with the use of the stapleless binder 5B.

The binding operation to be performed with the stapleless binder 5B moving from the dual-flat-binding position Pb2 to the corner-oblique-binding position Pb4 may be hindered by one of the lower-end-receiving members.

In the first exemplary embodiment, the one lower-end-receiving member is the rear lower-end-receiving member 43. Specifically, in the lower-end-receiving member 43, a portion 43x, hatched with oblique lines in FIG. 7B, may be the hindrance.

Herein, the hindrance means that the portion 43x of the lower-end-receiving member 43 may hinder the movement of the binder 5 (5B) to the binding position. The portion 43x of the lower-end-receiving member 43 may also hinder the binding action of the binder 5 at the binding position.

Consequently, corner oblique binding to be performed with the use of the stapleless binder 5B may be hindered by the rear lower-end-receiving member 43. Such a situation is referred to as Problem 2.

Herein, the expression “the binder 5 (5B)” means that the binder 5 of interest is the stapleless binder 5B.

The probability of Problems 1 and 2 tends to increase in the following situations.

Specifically, if the sheet processing device 2A has a reduced size in the widthwise direction E, the probability of Problems 1 and 2 tends to increase. In such a case, the positions of the lower-end-receiving members 41, 42, and 43 are restricted. Such a restriction increases the probability of interference between the lower-end-receiving members 41, 42, and 43 and the binder 5 (5A or 5B) at the binding position.

The normal positions J1, J2, and J3 of the lower-end-receiving members 41, 42, and 43 are defined at three respective positions where the lower-end-receiving members 41, 42, and 43 are supposed to come into contact with the lower end 19u of the sheet 19S having the smallest possible width Ws.

### (5) First Conjugate Movement Mechanism and Second Conjugate Movement Mechanism

The sheet processing device 2A includes a first conjugate movement mechanism 7 and a second conjugate movement mechanism 8 (see FIG. 8 and others), with which Problems 1 and 2 are addressed.

### (6-1) Configuration of First Conjugate Movement Mechanism

The first conjugate movement mechanism 7 is configured to move the front lower-end-receiving member 42 in conjunction with the movement of the binder 5 (5A or 5B).

The lower-end-receiving member 42 to be moved by the first conjugate movement mechanism 7 is set movably in the widthwise direction E that intersects the carry-in direction C.

The lower-end-receiving member 42 is provided on a movable member 425 (see FIGS. 8, 9, and others), which is movable in the widthwise direction E.

The movable member 425 is a plate member and is movable while being guided along a first guide bar 401, which is provided on the body 40 of the lower-end receiver 4. The movable member 425 is located below the lower-end-receiving member 42 and has such a shape as to support a rotatable lever 71 while allowing the rotatable lever 71 to rotate.

The movable member 425 has a guide-bar-receiving hole 425a in a face thereof extending in the carry-in direction C. The first guide bar 401 extends through the guide-bar-receiving hole 425a.

The first guide bar 401 extends in the widthwise direction E and is fixed at the two ends thereof to the attaching portion 402 and a holding portion 403, which are provided on the body 40.

Thus, the movable member 425 is movable in the directions E1 and E2 relative to the body 40 (see FIG. 8 and others). Accordingly, the lower-end-receiving member 42 is movable in the directions E1 and E2.

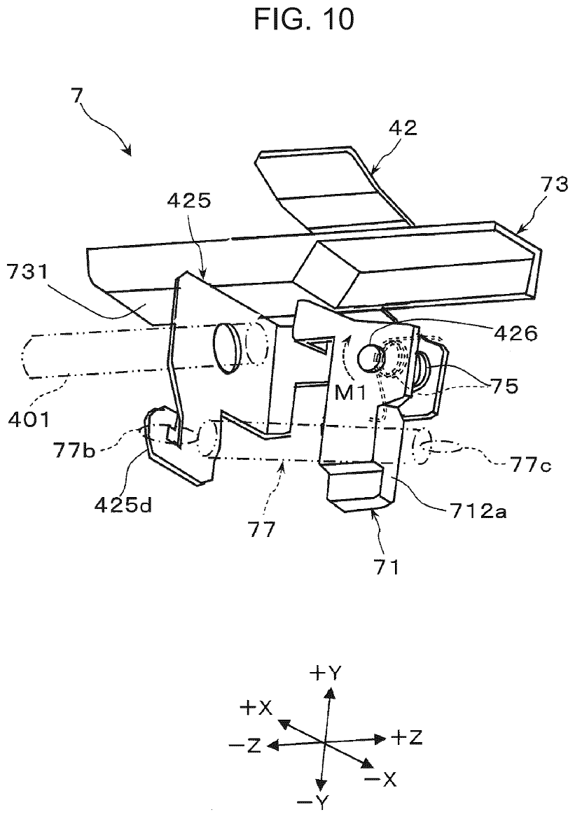

The first conjugate movement mechanism 7 includes the rotatable lever 71, a rotation controlling member 73, a rotation urging member 75, and a movement urging member 77 (see FIG. 10 and others).

The rotatable lever 71 includes a bearing portion 711, a first contact portion 712, and a second contact portion 713.

In the rotatable lever 71, the bearing portion 711 is rotatably fitted on a shaft 426. The shaft 426 projects from a lateral face of the movable member 425 and extends in the carry-in direction C. The bearing portion 711 has a shaft hole 711a, through which the shaft 426 rotatably extends.

The first contact portion 712 is allowed to come into contact with a portion of the binder 5 that is moving, at a position away from the bearing portion 711 in one direction.

The first contact portion 712 extends downward from the bearing portion 711. The first contact portion 712 includes a first contact surface 712a, which faces frontward; and a second contact surface 712b, which faces rearward.

The second contact portion 713 is in contact with the rotation controlling member 73 at a position away from the bearing portion 711 in a different direction from the first contact portion 712.

The second contact portion 713 has a shape extending obliquely upward from the bearing portion 711. The second contact portion 713 includes a contact part 713a, which is tapered upward.

The above-mentioned portion of the binder 5 is a corresponding one of contact members 608 and 609 (see FIGS. 5A and 5B), which are provided on the respective carriers 61 and 62 of the mover-supporter 6.

The contact members 608 and 609 each extend upward from an end of a corresponding one of the carriers 61 and 62 along a lateral face of the binder 5 (5A or 5B). The contact members 608 and 609 each include at the upper end thereof a portion that is bent toward the stacking plate 31. The bent portion of each of the contact members 608 and 609 is used as a contact portion 608a or 609a, which is designed to come into contact with the first contact portion 712.

The rotation controlling member 73 is fixedly provided at such a position as to face the second contact portion 713 of the rotatable lever 71.

The rotation controlling member 73 is a planar member as a whole and includes on one side thereof a first controlling surface 731 and a second controlling surface 732.

The first controlling surface 731 is a surface with which the second contact portion 713 of the rotatable lever 71 comes into contact so that the rotatable lever 71 is stopped from rotating in one direction M1.

The first controlling surface 731 is a flat surface extending in the widthwise direction E. The first controlling surface 731 has such a length as to allow the lower-end-receiving member 42 to move by at least a predetermined distance La in the widthwise direction E.

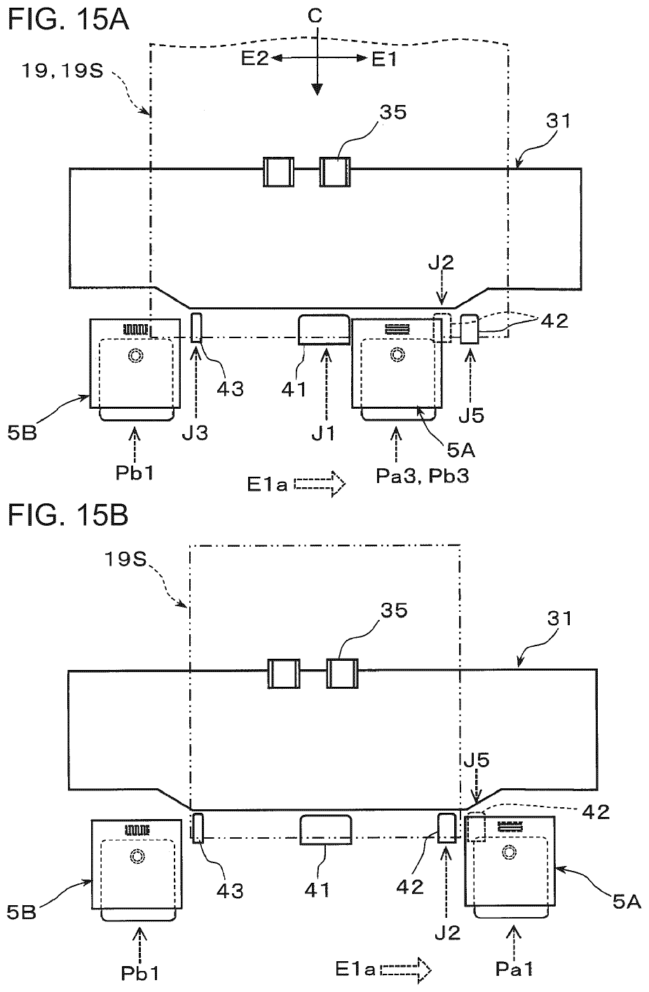

The predetermined distance La is the distance for the lower-end-receiving member 42 to travel from the normal position J2 at least to an avoiding position J5 (see FIGS. 15A and 15B).

The avoiding position J5 is defined for the lower-end-receiving member 42 to avoid hindering the binder 5 (5A or 5B) from performing a binding operation at the dual-flat-binding position Pa3 or Pb3.

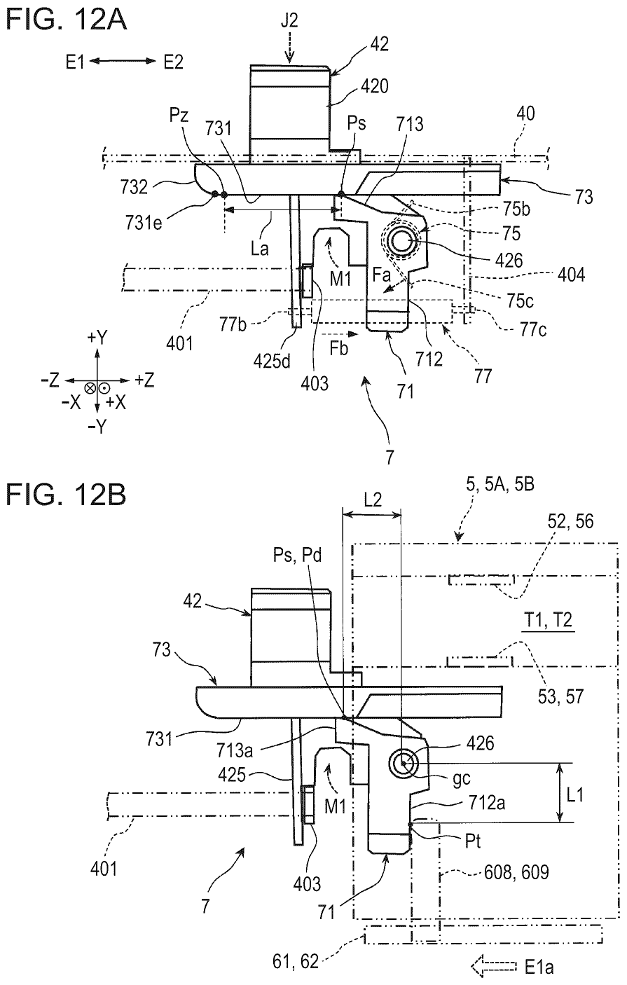

Referring to FIG. 12A, when the lower-end-receiving member 42 is at the normal position J2, the second contact portion 713 is in contact with the first controlling surface 731 at a point Ps. The point Ps is hereinafter referred to as normal contact point Ps. The normal contact point Ps is also regarded as a contact point for the rotatable lever 71 to be stopped from rotating in normal times.

Referring to FIG. 12A, when the lower-end-receiving member 42 is at the avoiding position J5, the second contact portion 713 is in contact with the first controlling surface 731 at a point Pz. The point Pz is hereinafter referred to as avoiding contact point Pz. The avoiding contact point Pz is also regarded as a contact point for the rotatable lever 71 to be stopped from rotating when the lower-end-receiving member 42 is at the avoiding position J5.

The second controlling surface 732 is a surface with which the rotatable lever 71 is controlled to rotate in the one direction M1.

The second controlling surface 732 is curved in a direction gradually away from the first controlling surface 731. The second controlling surface 732 is continuous with a terminal end 731e of the first controlling surface 731.

The direction away from the first controlling surface 731 refers to a direction shifted upward from the first controlling surface 731 (a direction toward the other side of the rotation controlling member 73). In short, the direction away from the first controlling surface 731 is a direction from the first controlling surface 731 toward the other side of the rotation controlling member 73.

The second controlling surface 732 forms an arc shape or any other curved shape.

The rotation controlling member 73 is attached to the lower surface of the body 40 of the lower-end receiver 4 (see FIG. 9).

The rotation controlling member 73 is set such that the first controlling surface 731 thereof faces and is in contact with the second contact portion 713 of the rotatable lever 71. In such a setting, the second contact portion 713 of the rotatable lever 71 is in contact with the normal contact point Ps of the first controlling surface 731 (see FIG. 12A).

The rotation urging member 75 is intended to apply an urging force Fa to the rotatable lever 71. The urging force Fa causes the rotatable lever 71 to rotate in the one direction M1.

The rotation urging member 75 may be, for example, a torsion spring (see FIG. 12A).

The torsion spring serving as the rotation urging member 75 is fitted at the coil portion thereof on the shaft 426. The torsion spring includes one arm 75b, which is attached to a portion of the movable member 425. The torsion spring further includes another arm 75c, which is attached to the first contact portion 712 of the rotatable lever 71 in such a manner as to apply the urging force Fa.

The rotation urging member 75 constantly exerts the urging force Fa that causes the rotatable lever 71 to rotate in the one direction M1 (see FIG. 12A).

Thus, the rotatable lever 71 is kept in contact at the second contact portion 713 thereof with the first controlling surface 731 of the rotation controlling member 73.

The movement urging member 77 is intended to apply an urging force Fb to the movable member 425. The urging force Fb causes the lower-end-receiving member 42 to return to the normal position J1.

The movement urging member 77 may be, for example, a tension spring (see FIG. 12A).

The tension spring serving as the movement urging member 77 includes a hook 77b at one end of the coil portion thereof. The hook 77b is hooked on a catcher 425d, which is included in the movable member 425. The tension spring further includes a hook 77c at the other end of the coil portion thereof. The hook 77c is hooked on a catcher 404d such that the urging force Fb is generated. The catcher 404d is included in a holding portion 404.

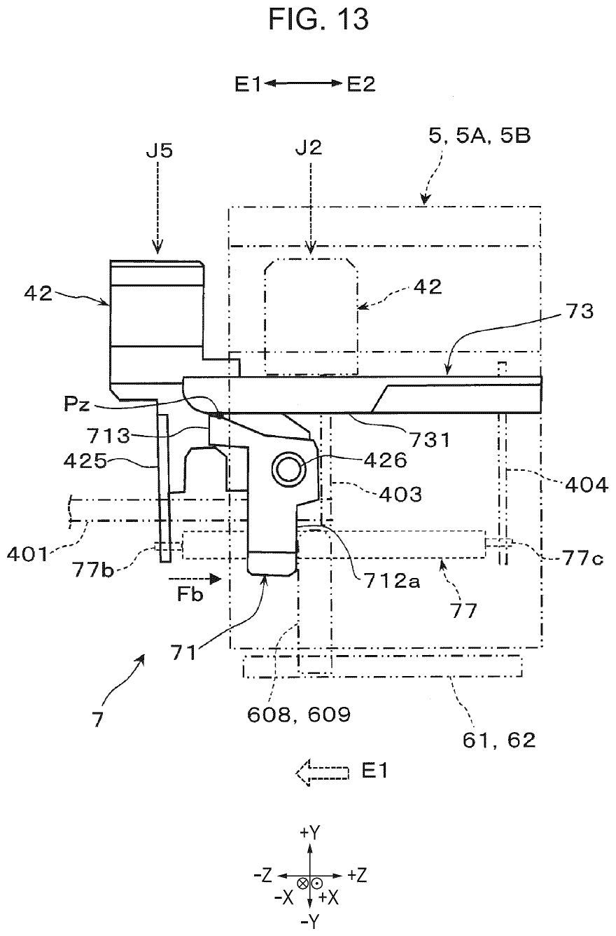

When the movement urging member 77 is stretched with the movement of the movable member 425 and so forth, the movement urging member 77 exerts the urging force Fb that acts to pull back the movable member 425 (see FIG. 13). The urging force Fb is also active when the movable member 425 is stationary in normal times.

Therefore, in normal times in which the movable member 425 is stationary, the movable member 425 is kept in contact with the holding portion 403. Furthermore, when the movable member 425 moves in the direction E1, the lower-end-receiving member 42 inclusive of the movable member 425 is returned to the initial position.

### (6-2) Position of First Conjugate Movement Mechanism

The first conjugate movement mechanism 7 is positioned in such a manner as to allow the rotatable lever 71 to come into contact with a portion of the binder 5 (5A or 5B) that is moving.

In this case, the binder 5 approaches the dual-flat-binding position Pa3 or Pb3 from the rear side or the front side.

The first conjugate movement mechanism 7 is located below the body 40 of the lower-end receiver 4 (see FIG. 9).

The first conjugate movement mechanism 7 is set such that the lower-end-receiving member 42 is stationary at the normal position J2 (see FIGS. 8, 12A, and 12B).

In normal times, the first conjugate movement mechanism 7 is in a position illustrated in FIGS. 12A and 12B and others. In such a normal time, the portion of the binder 5 (5A or 5B) is out of contact with the rotatable lever 71.

Initially, the first conjugate movement mechanism 7 is positioned with the second contact portion 713 of the rotatable lever 71 being in contact with the first controlling surface 731 of the rotation controlling member 73.

In this position, the rotatable lever 71 is under the urging force Fa exerted by the rotation urging member 75 and acting to rotate the rotatable lever 71 in the one direction M1. Nevertheless, the rotatable lever 71 in this position is stationary because the rotation in the one direction M1 is stopped by the first controlling surface 731.

Furthermore, in the above position of the first conjugate movement mechanism 7, the lower-end-receiving member 42 is kept stationary at the normal position J2 by the movable member 425.

In this position, the movable member 425 is under the urging force Fb exerted by the movement urging member 77 and is thus kept stationary while being in contact with the holding portion 403 of the body 40. With the movable member 425 being stationary, the lower-end-receiving member 42 stays at the normal position J2.

Furthermore, in the above position of the first conjugate movement mechanism 7, the first contact portion 712 of the rotatable lever 71 hangs down from the bearing portion 711.

Therefore, the first contact portion 712 of the rotatable lever 71 is allowed to come into contact with a portion of the binder 5 (5A or 5B). The portion of the binder 5 (5A or 5B) in this case is the contact member 608 or 609 (see FIG. 12B).

The first contact portion 712 of the rotatable lever 71 in this case comes into contact with the portion of the binder 5 (5A or 5B) in either of the following two ways.

In a first way of contact, the portion of the binder 5 (5A or 5B) comes into contact with the first contact surface 712a of the first contact portion 712. The first way of contact is exemplified in FIG. 12A.

In the first way, the contact occurs when the binder 5 approaches the dual-flat-binding position Pa3 or Pb3 from the rear side.

This movement of the binder 5 is also expressed as a movement in a first specific direction E1a toward a predetermined binding position.

The predetermined binding position corresponds to the dual-flat-binding position Pa3 or Pb3. The first specific direction E1a corresponds to a direction approaching the dual-flat-binding position Pa3 or Pb3 from the rear side (see FIG. 12B).

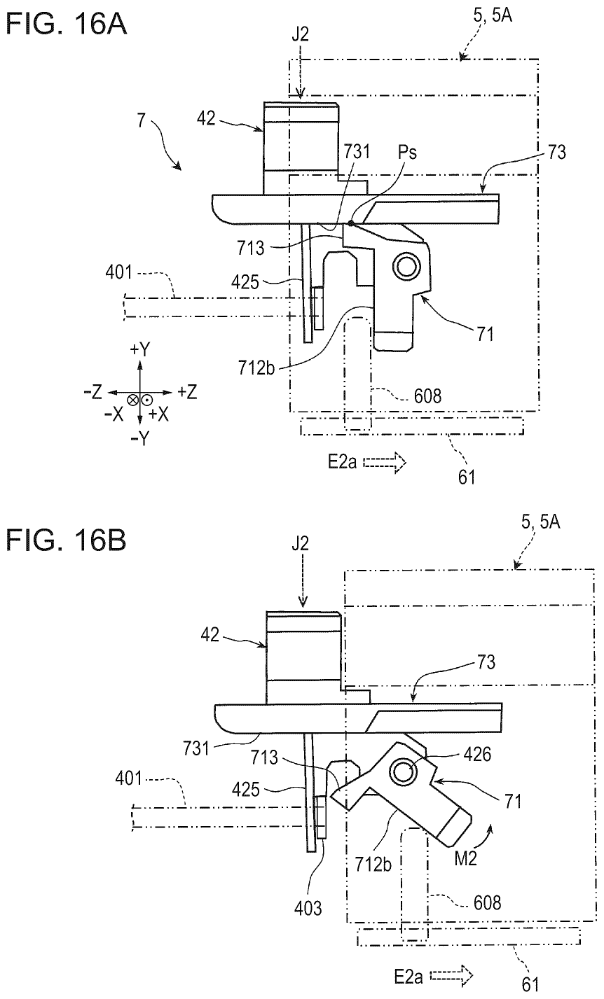

In a second way of contact, the portion of the binder 5 (5A or 5B) comes into contact with the second contact surface 712b of the first contact portion 712. The second way of contact is exemplified in FIG. 16A.

In the second way, the contact occurs when the binder 5 approaches the dual-flat-binding position Pa3 or Pb3 from the front side.

This movement of the binder 5 is also expressed as a movement in an opposite direction E2a, which is opposite to the first specific direction E1a, toward a predetermined binding position. The opposite direction E2a corresponds to a direction approaching the dual-flat-binding position Pa2 or Pb2 from the front side (see FIG. 16A).

### (6-3) Behavior of First Conjugate Movement Mechanism

How the first conjugate movement mechanism 7 behaves will now be described.

(a) Case where Binder 5 (5A or 5B) Moves in First Specific Direction E1a to Dual-Flat-Binding Position Pa3 or Pb3

In the present case, the first conjugate movement mechanism 7 behaves such that a portion of the binder 5 (5A or 5B) that is moving comes into contact with the first contact portion 712 of the rotatable lever 71. Specifically, the contact member 608 or 609 of the binder 5 (5A or 5B) comes into contact with the first contact surface 712a of the first contact portion 712.

In this phase, the rotatable lever 71 is pushed at the first contact portion 712 in the first specific direction E1a and tends to rotate in the one direction M1. Nevertheless, since the second contact portion 713 of the rotatable lever 71 is in contact with the first controlling surface 731 of the rotation controlling member 73, the rotatable lever 71 does not rotate.

Instead, the rotatable lever 71 thus pushed moves in the first specific direction E1a with the second contact portion 713 thereof being kept in contact with the first controlling surface 731.

Then, the binder 5 (5A or 5B) stops at the dual-flat-binding position Pa3 or Pb3, and the rotatable lever 71 stops moving.

In the present case, the rotatable lever 71 moves such that the second contact portion 713 thereof moves from the normal contact point Ps by a predetermined distance La along the first controlling surface 731.

Furthermore, the rotatable lever 71 stops when the second contact portion 713 that is kept in contact with the first controlling surface 731 reaches the avoiding contact point Pz.

The above movement of the rotatable lever 71 causes the movable member 425 to move therealong.

In the present case, the movable member 425 moves in the first specific direction E1a (the direction E1) while being guided along the first guide bar 401.

With this movement of the movable member 425, the movement urging member 77 is stretched, whereby the urging force Fb increases.

Consequently, the first conjugate movement mechanism 7 moving the movable member 425 moves the lower-end-receiving member 42 in the first specific direction E1a.

In the present case, the lower-end-receiving member 42 moves by the predetermined distance La from the normal position J2 (see FIG. 12A). Thus, the lower-end-receiving member 42 is moved to the avoiding position J5 and stops there (see FIG. 13).

To summarize, in the sheet processing device 2A, when the binder 5 (5A or 5B) approaches the dual-flat-binding position Pa3 or Pb3 from the rear side, the lower-end-receiving member 42 moves to the avoiding position J5.

That is, in the present case, the lower-end-receiving member 42 that is at the normal position J2 is moved to the avoiding position J5 in conjunction with the movement of the binder 5.

The present case is exemplified in FIG. 15A.

(b) Case where Binder 5 (5A) Further Moves in First Specific Direction E1a from Dual-Flat-Binding Position Pa3

Accordingly, the second contact portion 713 of the rotatable lever 71 moves from the first controlling surface 731 to the second controlling surface 732. Specifically, the second contact portion 713 moves past the terminal end 731e of the first controlling surface 731 to the second controlling surface 732.

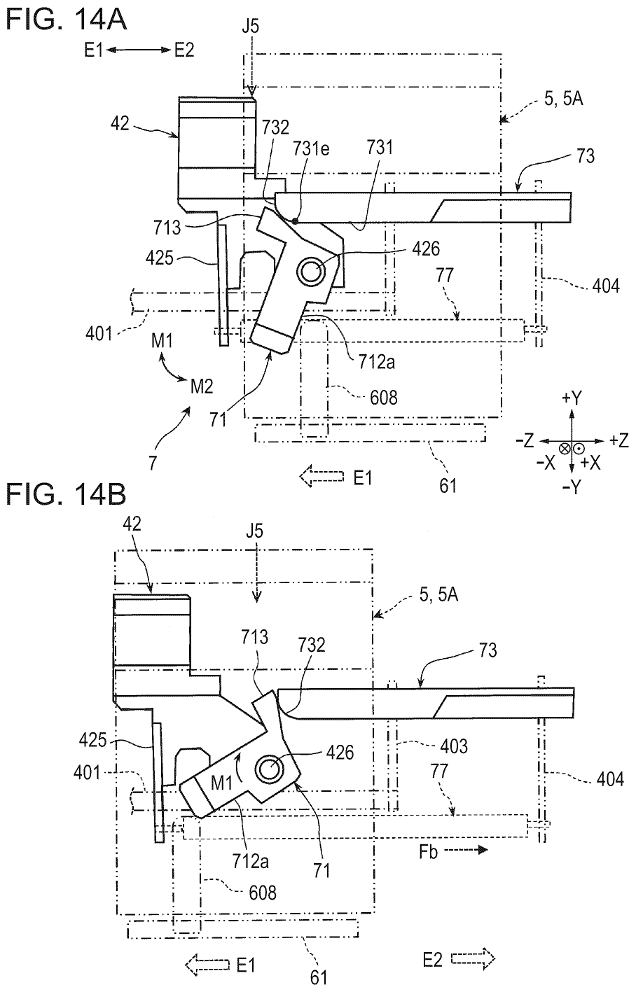

Since the second contact portion 713 comes into contact with and moves along the second controlling surface 732, the rotatable lever 71 starts to rotate in the one direction M1. This phase is exemplified in FIG. 14A.

Furthermore, since the rotatable lever 71 rotates in the one direction M1, the urging force Fa exerted by the rotation urging member 75 is reduced.

When the binder 5 (5A) further moves in the first specific direction E1a, the portion of the binder 5 (5A) goes out of contact with the first contact portion 712. This phase is exemplified in FIG. 14B. FIG. 14B illustrates a moment when the first contact portion 712 of the rotatable lever 71 goes out of contact with the contact member 608.

Thus, the movable member 425 is moved by the urging force Fb of the movement urging member 77 back to the initial position.

The movable member 425 in this phase moves in the direction E2 while being guided along the first guide bar 401.

The rotatable lever 71 in this phase is rotated in an opposite direction M2, which is opposite to the one direction M1. The rotatable lever 71 during this rotation is illustrated in FIG. 14A (with the binder 5 ignored).

Meanwhile, since the rotatable lever 71 rotates in the opposite direction M2, the urging force Fa of the rotation urging member 75 starts to resume the initial level.

Accordingly, the second contact portion 713 of the rotatable lever 71 moves from the second controlling surface 732 to the first controlling surface 731 while being in contact therewith.

The rotatable lever 71 changes its position from the one illustrated in FIG. 14A to the one illustrated in FIG. 13, and then returns to the one illustrated in FIG. 12A. In this description of the positions, the binder 5 is ignored.

Thus, the first conjugate movement mechanism 7 returns the lower-end-receiving member 42 to the initial position in conjunction with the further movement of the binder 5 (5A).

Specifically, the lower-end-receiving member 42 returns to the initial position in conjunction with the movement of the stapling binder 5A from the dual-flat-binding position Pa3 to the standby position Pa1.

That is, the lower-end-receiving member 42 is returned from the avoiding position J5 to the normal position J2 as illustrated in FIG. 15B.

Accordingly, the lower-end-receiving member 42 becomes ready to receive and hold the lower end 19u of the sheet 19S having the smallest possible width Ws.

In the movement of the stapling binder 5A to the standby position Pa1, the stapling binder 5A may first go past the standby position Pa1 and then return to the standby position Pa1. Thus, the contact between the contact member 608 of the stapling binder 5A and the first contact portion 712 of the rotatable lever 71 is assuredly undone.

On the other hand, the binder 5 (5B) moves to the standby position Pb1 if no binding operation is to be performed at any of the binding positions other than the dual-flat-binding position Pb3.

In such a case, the binder 5 (5B) moves in the direction E2a, opposite to the first specific direction E1a, from the dual-flat-binding position Pb3.

In this movement, the rotatable lever 71 of the first conjugate movement mechanism 7 moves in the opposite direction E2a with the first contact portion 712 thereof being kept in contact with a portion of the binder 5 (5B).

Accordingly, the movable member 425 moves in the opposite direction E2a along with the rotatable lever 71 and returns to the initial position. Furthermore, a portion of the movable member 425 comes into contact with the holding portion 403 of the body 40 of the lower-end receiver 4, whereby the movable member 425 stops.

In such a case as well, the first conjugate movement mechanism 7 returns the lower-end-receiving member 42 to the initial position in conjunction with the movement of the binder 5 (5B).

Specifically, the lower-end-receiving member 42 is returned to the initial position in conjunction with the movement of the stapleless binder 5B from the dual-flat-binding position Pb3 to the standby position Pb1.

That is, in such a case as well, the lower-end-receiving member 42 is moved and returned to the normal position J2 (see FIG. 15B).

(c) Case where Binder 5 (5A) Moves from Standby Position Pa1 in Direction E2a Opposite to First Specific Direction E1a

In the present case, the binder 5 (5A) moves from the standby position Pa1 and past the lower-end-receiving member 42. Moving past the lower-end-receiving member 42 is also regarded as moving past the dual-flat-binding position Pa3.

In the present case, a portion of the binder 5 (5A) that is moving comes into contact with the second contact surface 712b of the first contact portion 712 of the rotatable lever 71. The portion of the binder 5 (5A) in the present case is the contact member 608.

In the present case, the first contact portion 712 of the rotatable lever 71 is pushed in the opposite direction E2a, whereby the rotatable lever 71 starts to rotate in the direction M2 opposite to the one direction M1. Accordingly, the second contact portion 713 of the rotatable lever 71 goes out of contact with the first controlling surface 731 of the rotation controlling member 73. The rotatable lever 71 in this phase is exemplified in FIG. 16B.

Furthermore, with the rotation of the rotatable lever 71 in the opposite direction M2, the urging force Fa exerted by the rotation urging member 75 increases.

Subsequently, the binder 5 (5A) moves past the lower-end-receiving member 42, and the portion of the binder 5 (5A) goes out of contact with the first contact portion 712 of the rotatable lever 71.

In this phase, the rotatable lever 71 rotates in the one direction M1 under the urging force Fa of the rotation urging member 75 and returns to the normal position. Accordingly, the second contact portion 713 of the rotatable lever 71 comes into contact with the first controlling surface 731 of the rotation controlling member 73 again. The rotatable lever 71 in this phase is exemplified in FIG. 12A.

To summarize, the rotatable lever 71 does not move in the opposite direction E2a in conjunction with the movement of the binder 5 (5A) in the opposite direction E2a and stays at the initial position.

Accordingly, the movable member 425 and the lower-end-receiving member 42 do not move and remain stationary.

That is, the lower-end-receiving member 42 in the present case is stationary at the normal position J2.

Thus, the first conjugate movement mechanism 7 does not move the lower-end-receiving member 42 when the binder 5 (5A) moves past the lower-end-receiving member 42 from the front side.

### (d) Other Features of First Conjugate Movement Mechanism

The first conjugate movement mechanism 7 that behaves as described above is activated in conjunction with the movement of the binder 5 (5A or 5B).

### (6-4) Other Configurations Relevant to First Conjugate Movement Mechanism

In the first conjugate movement mechanism 7, the rotatable lever 71 has a first smallest length L1 and a second smallest length L2, which are in a relationship of L1<L2.

The first smallest length L1 is the length between a first contact point Pt and an axis gc of the shaft 426. The first contact point Pt is a point closest to the shaft 426 in a part of the first contact portion 712 where the first contact portion 712 comes into contact with a portion of the binder 5 (5A or 5B).

The second smallest length L2 is the length between a second contact point Pd and the axis gc. The second contact point Pd is a point closest to the shaft 426 in a part of the second contact portion 713 where the second contact portion 713 comes into contact with the first controlling surface 731. The second contact point Pd is included in the normal contact point Ps.

The first smallest length L1 and the second smallest length L2 are exemplified in FIG. 12B.

The first smallest length L1 and the second smallest length L2 may be in a relationship of (L1/L2)≥1.3.

In the sheet processing device 2A, the speed of travel of the binder 5 (5A or 5B) is adjusted in the movement approaching the dual-flat-binding position Pa3 or Pb3 from the rear side.

Specifically, the mover-supporter 6 reduces the speed of travel of the binder 5 (5A or 5B) before a portion of the binder 5 comes into contact with the first contact portion 712 of the rotatable lever 71. The adjustment of the speed of travel is implemented by reducing the driving speed of the drive source 651 or 661 of the mover-supporter 6 immediately before the contact.

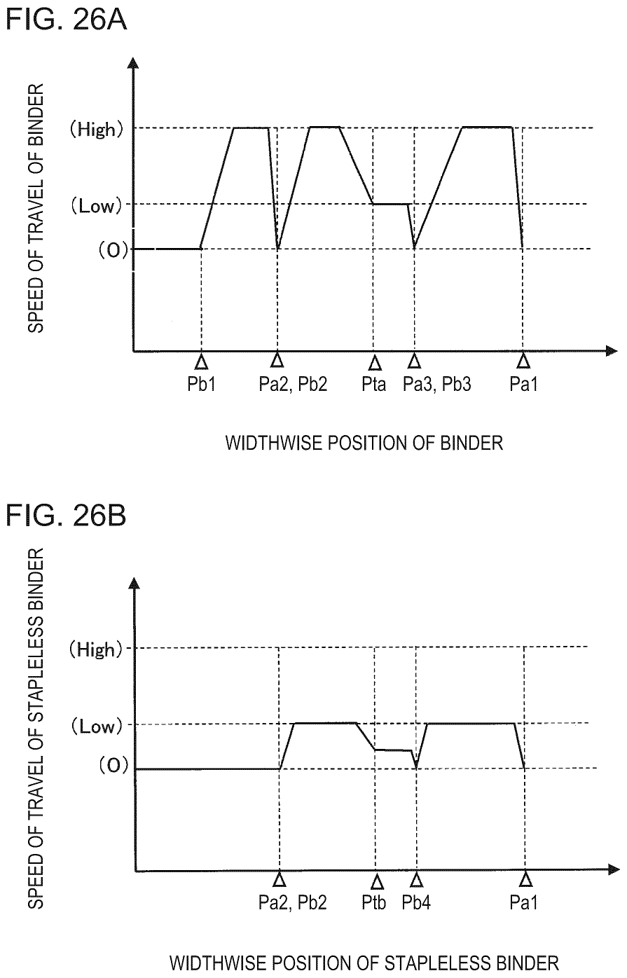

The degree of adjustment of the speed of travel is exemplified in FIG. 26A.

Reference sign Pta given in FIG. 26A denotes a preliminary position that is reached by the binder 5 (5A or 5B) before a portion of the binder 5 (5A or 5B) comes into contact with the first contact portion 712. FIG. 26A illustrates that the speed of travel is reduced at the preliminary position Pta. In the case exemplified in FIG. 26A, the speed of travel is changed at the preliminary position Pta from a high speed to a low speed.

In the sheet processing device 2A, the mover-supporter 6 is configured to move the stapling binder 5A to the staple refilling position.

The staple refilling position is defined at a position past the corner-oblique-binding position Pa4 toward the front side. The stapling binder 5A to be moved to the refilling position is guided along the guide groove 64 of the orientation guide plate 63 up to a terminal end 642e of the first curved guide portion 642. The housing 20 has a door (not illustrated) at a location corresponding to the refilling position.

In the first exemplary embodiment, the stapling binder 5A is located on the front side relative to the stapleless binder 5B.

The sheet processing device 2A is provided on the inside (output accommodation part 15) of the housing 11 of the image forming apparatus 10A. That is, the sheet processing device 2A tends to be restricted by the dimensions of the housing 11 and is to be installed in a relatively narrow space.

Nevertheless, the sheet processing device 2A includes the first conjugate movement mechanism 7 configured to behave as described above.

### (7-1) Configuration of Second Conjugate Movement Mechanism

The second conjugate movement mechanism 8 is configured to move the rear lower-end-receiving member 43 in conjunction with the movement of the binder 5 (5B).

The lower-end-receiving member 43 to be moved by the second conjugate movement mechanism 8 is set movably in the widthwise direction E that intersects the carry-in direction C.

The lower-end-receiving member 43 is provided on a movable member 435 (see FIGS. 8, 9, and others), which is movable in the widthwise direction E.

The movable member 435 is a plate member and is movable while being guided along a second guide bar 405, which is provided on the body 40 of the lower-end receiver 4. The movable member 435 includes a body that is bent in an L shape. The movable member 435 has a guide-bar-receiving portion 435a, through which the second guide bar 405 is passed to be received.

The second guide bar 405 extends in the widthwise direction E and is fixed at the two ends thereof to respective holding portions 406 and 407, which are provided on the body 40.

Thus, the movable member 435 is movable in the directions E1 and E2 relative to the body 40 (see FIG. 8 and others). Accordingly, the lower-end-receiving member 43 is movable in the directions E1 and E2.

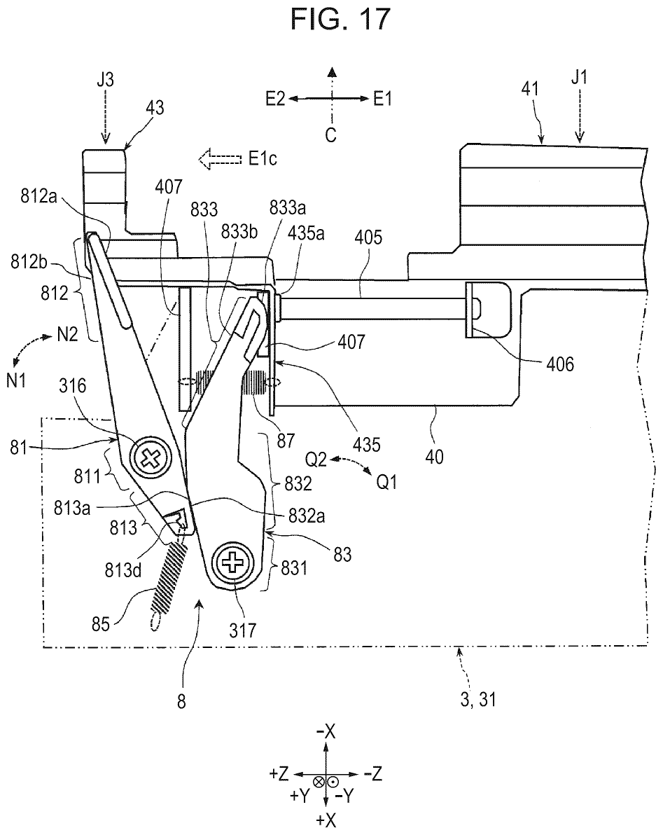

The second conjugate movement mechanism 8 includes a rotatable lever 81, a swingable lever 83, a rotation urging member 85, and a movement urging member 87 (see FIG. 17 and others).

The rotatable lever 81 includes a first bearing portion 811, a first contact portion 812, and a second contact portion 813.

In the rotatable lever 81, the first bearing portion 811 is rotatably fitted on a first shaft 316.

The first shaft 316 projects from the lower surface of the stacking plate 31 of the collecting part 3 at a position relatively close to the lower-end-receiving member 43. The first bearing portion 811 has a shaft hole (not illustrated), through which the first shaft 316 rotatably extends.

The first contact portion 812 extends from the first bearing portion 811 toward one side and is designed to come into contact with the body of the binder 5 (5B) that is moving.

The first contact portion 812 extending from the first bearing portion 811 is tapered in one direction. The first contact portion 812 projects relative to the movable member 435 into a path for a portion of the binder 5 (5B) to move.

The first contact portion 812 includes a first contact surface 812a and a second contact surface 812b. The first contact surface 812a is a contact surface on one side that faces frontward to come into contact with the portion of the binder 5 (5B). The second contact surface 812b is a contact surface on the other side that faces rearward.

The portion of the binder 5 (5B) is a portion of the body 51. The portion of the body 51 will be detailed separately below.

The second contact portion 813 is in contact with the swingable lever 83 at a position away from the first bearing portion 811 and on the other side opposite the first contact portion 812.

The second contact portion 813 extending from the first bearing portion 811 is tapered in the other direction.

The second contact portion 813 includes a contact surface 813a, which faces frontward and is in contact with a cam portion 832, to be described below, of the swingable lever 83.

The second contact portion 813 further includes at the distal end thereof a catcher 813d, which is an incision and at which one end of the rotation urging member 85 is hooked.

The swingable lever 83 includes a second bearing portion 831, the cam portion 832, and a pushing portion 833.

In the swingable lever 83, the second bearing portion 831 is rotatably fitted on a second shaft 317.

The second shaft 317 projects from the lower surface of the stacking plate 31 of the collecting part 3 at a position away from the first shaft 316. The second shaft 317 is located at a position farther from the lower-end-receiving member 43 than the first shaft 316 is and on the front side relative to the first shaft 316.

The second bearing portion 831 has a shaft hole (not illustrated), through which the second shaft 317 rotatably extends.

The cam portion 832 extends from the second bearing portion 831 toward the first shaft 316 and is in contact with the second contact portion 813.

The cam portion 832 has a shape extending from the second bearing portion 831 to a position close to the first shaft 316 provided for the rotatable lever 81.

The cam portion 832 includes a cam surface 832a, which faces the second contact portion 813 of the rotatable lever 81.

The cam surface 832a is a predetermined curved surface extending from the second bearing portion 831 to the position close to the first shaft 316. The second contact portion 813 of the rotatable lever 81 is in contact with the cam surface 832a.

The pushing portion 833 is designed to be in contact with the movable member 435 and push the movable member 435 in an opposite direction E1c, which is opposite to a second specific direction E2c to be described below.

The pushing portion 833 has a shape extending from the cam portion 832 toward a side opposite the second bearing portion 831 while bending. The pushing portion 833 is in contact at the distal end thereof with the movable member 435.

The pushing portion 833 includes a contact surface 833a, which is in contact with the movable member 435. The contact surface 833a is curved for smooth contact with the movable member 435 during the movement.

The pushing portion 833 includes an inclined surface 833b, which is located opposite the contact surface 833a. The inclined surface 833b is inclined gradually away from the first contact surface 812a of the rotatable lever 81.

The rotation urging member 85 is intended to apply an urging force to the rotatable lever 81. The urging force causes the rotatable lever 81 to rotate in a direction opposite to the direction in which the rotatable lever 81 is to be rotated.

The direction in which the rotatable lever 81 is to be rotated refers to either of directions N1 and N2 about the first shaft 316 (see FIG. 17).

The urging force includes an urging force Fc, which causes the rotation in the direction N2; and an urging force Fd, which causes the rotation in the direction N1.

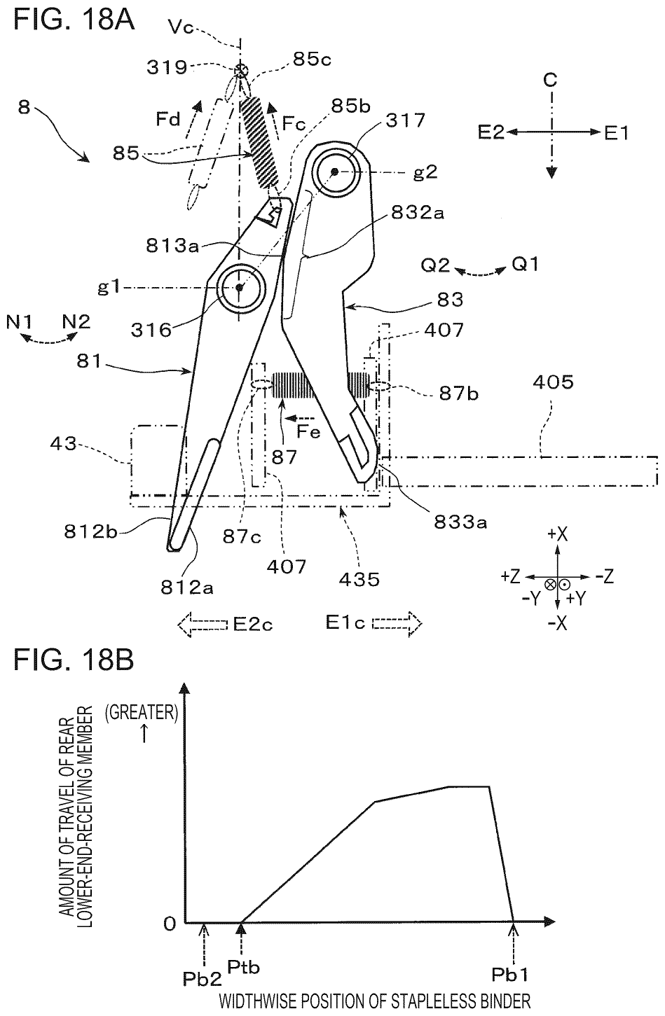

The rotation urging member 85 may be, for example, a tension spring (see FIG. 18A).

The tension spring serving as the rotation urging member 85 includes a hook 85c at one end of the coil portion thereof. The hook 85c is hooked on a catcher 319, which is provided on the lower surface of the stacking plate 31. The tension spring further includes a hook 85b at the other end of the coil portion thereof. The hook 85b is hooked on the catcher 813d included in the rotatable lever 81.

The catcher 319 is located, for example, on a virtual line Vc, which extends from an axis g1 of the first shaft 316 provided for the rotatable lever 81. The virtual line Vc is a virtual straight line extending in the carry-in direction C from the axis g1 of the first shaft 316 toward the upstream side in the carry-in direction C.

Hence, when the rotatable lever 81 rotates in the direction N1, the rotation urging member 85 exerts the urging force Fc that causes the rotatable lever 81 to rotate reversely. On the other hand, when the rotatable lever 81 rotates in the direction N2, the rotation urging member 85 exerts the urging force Fd that causes the rotatable lever 81 to rotate reversely.

The position of the catcher 319 may be defined on the rear side relative to the virtual line Vc.

The movement urging member 87 is intended to apply an urging force Fe to the movable member 435. The urging force Fe causes the lower-end-receiving member 43 to return to the normal position J3.

The movement urging member 87 may be, for example, a tension spring (see FIG. 18A).

The tension spring serving as the movement urging member 87 includes a hook 87b at one end of the coil portion thereof. The hook 87b is hooked on a portion of the movable member 435. The tension spring further includes a hook 87c at the other end of the coil portion thereof. The hook 87c is hooked on a part of the holding portion 407 in such a manner as to exert the urging force Fe.

When the movement urging member 87 is stretched with the movement of the movable member 435 and so forth, the movement urging member 87 exerts the urging force Fe that acts to pull back the movable member 435 (see FIG. 18A). The urging force Fe is also active when the movable member 435 is stationary in normal times.

Therefore, in normal times in which the movable member 435 is stationary, the movable member 435 is kept in contact with the holding portion 407. Furthermore, when the movable member 435 moves in the direction E1, the lower-end-receiving member 43 inclusive of the movable member 435 is returned to the initial position.

### (7-2) Position of Second Conjugate Movement Mechanism

The second conjugate movement mechanism 8 is positioned in such a manner as to allow the rotatable lever 81 to come into contact with a portion of the binder 5 (5B) that is moving.

In this case, the binder 5 (5B) approaches the corner-oblique-binding position Pb4 from the front side. The movement of the binder 5 (5B) includes a movement from the standby position Pb1 to the dual-flat-binding position Pb2.

The second conjugate movement mechanism 8 is located below the body 40 of the lower-end receiver 4 (see FIGS. 8 and 9).

The second conjugate movement mechanism 8 is set such that the lower-end-receiving member 43 is stationary at the normal position J3 (see FIGS. 8 and 17).

In normal times, the second conjugate movement mechanism 8 is in a position illustrated in FIGS. 17, 19, and others.

In such a normal time, a portion of the binder 5 (5B) is out of contact with or just about to come into contact with the rotatable lever 81.

The portion of the binder 5 (5B) in this case is a portion of the body 51. In the first exemplary embodiment, the portion of the body 51 is a lateral face 55a, which is a portion of the outer wall of the body 51 and extends from a rear corner 55r to a front corner 55f (see FIG. 19).

In normal times, the rotatable lever 81 is positioned such that the first contact portion 812 is ready to come into contact with the portion of the binder 5 (5B) that is moving in the second specific direction E2c. This position is exemplified in FIG. 19.

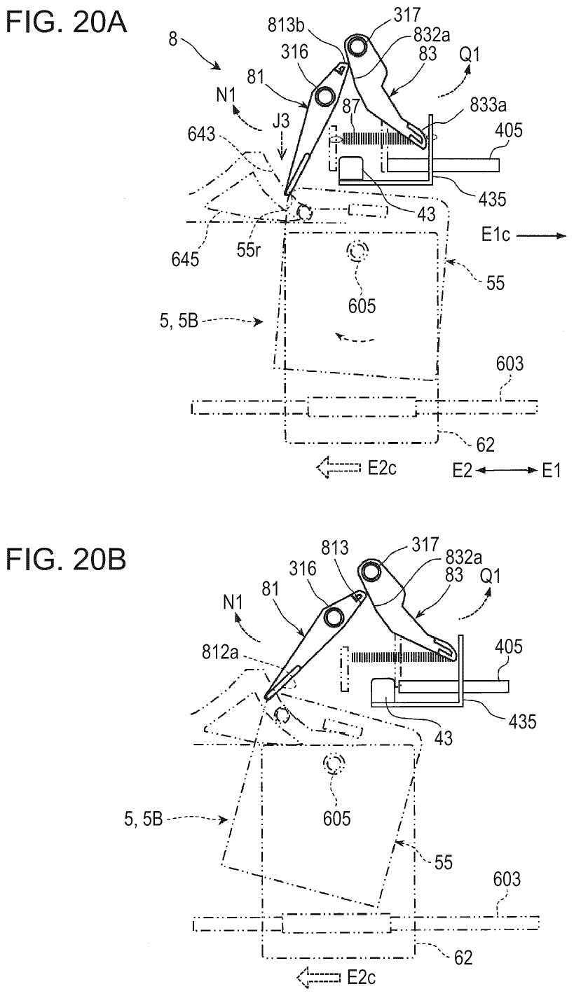

The second specific direction E2c corresponds to a direction for the stapleless binder 5B to approach the corner-oblique-binding position Pb4 from the front side. Specifically, the second specific direction E2c corresponds to a direction for the stapleless binder 5B to move from the dual-flat-binding position Pb2 toward the corner-oblique-binding position Pb4. The second specific direction E2c is represented in FIGS. 20A and 20B and others.

In the second conjugate movement mechanism 8, the second contact portion 813 of the rotatable lever 81 is in contact with the cam portion 832 of the swingable lever 83. Specifically, a part of the contact surface 813a of the second contact portion 813 is in contact with a part of the cam surface 832a of the cam portion 832.

As an alternative configuration, the second contact portion 813 of the rotatable lever 81 may be out of contact with the cam portion 832 of the swingable lever 83 when not active. In such a configuration, the rotatable lever 81 starts to come into contact with the cam portion 832 of the swingable lever 832 when coming into contact with the portion of the binder 5 (5B).

As to be described below, the rotatable lever 81 and the swingable lever 83 may be configured to operate at least in conjunction with the contact between the portion of the binder 5 that is moving and the first contact portion 812 of the rotatable lever 81. That is, the rotatable lever 81 may move at least such that the above contact causes the second contact portion 813 to come into contact with the cam portion 832 of the swingable lever 83. In this movement, the second contact portion 813 of the rotatable lever 81 touches and pushes the cam surface 832a of the cam portion 832 of the swingable lever 83 at a point near the second shaft 317, as to be described below. Thus, the swingable lever 83 swings.

In normal times, in the second conjugate movement mechanism 8, the rotatable lever 81 and the swingable lever 83 are positioned as follows.

Specifically, a distal end 813b of the second contact portion 813 is in contact with the cam surface 832a of the cam portion 832 at the point near the second shaft 317. This position is exemplified in FIG. 19. The point near the second shaft 317 refers to a point that is located on a line connecting the axis g1 of the first shaft 316 and an axis g2 of the second shaft 317 and between the midpoint of the line and the axis g2.

When the second conjugate movement mechanism 8 is active, the rotatable lever 81 and the swingable lever 83 behave as follows.

Specifically, the swingable lever 83 swings by a greater amount in the first half of the swing than in the second half of the swing.

The amount of swing in the first half refers to the amount by which the swingable lever 83 swings in an early phase of the rotation of the rotatable lever 81 in the direction N1. The rotation of the rotatable lever 81 occurs when the portion of the binder 5 (5B) comes into contact with the first contact portion 812. With this rotation, the swingable lever 83 swings in a direction Q1 about the second shaft 317.

The amount of swing in the second half refers to the amount by which the swingable lever 83 swings in a latter phase of the rotation of the rotatable lever 81 in the direction N1.

The amount of swing of the swingable lever 83 is regarded as the amplitude (central angle) of the swing with reference to the second shaft 317.

To implement the above behavior, the cam surface 832a includes a first surface portion extending substantially flat from the second bearing portion 831 to a position before the first shaft 316.

The cam surface 832a further includes a second surface portion extending from the terminal end of the first surface portion while curving in a direction away from the first shaft 316.

In the second conjugate movement mechanism 8, the first contact portion 812 of the rotatable lever 81 and the pushing portion 833 of the swingable lever 83 are designed as follows.

The first contact portion 812 and the pushing portion 833 are shaped such that a gap Sg is produced between the two in normal times. The gap Sg is gradually widened in a direction away from the first shaft 316. The gap Sg is a V-shaped space defined between the first contact surface 812a of the first contact portion 812 and the inclined surface 833b of the pushing portion 833 (see FIG. 19).

### (7-3) Behavior of Second Conjugate Movement Mechanism

How the second conjugate movement mechanism 8 behaves will now be described.

(a) Case where Binder 5 (5B) Moves in Second Specific Direction E2c to Corner-Oblique-Binding Position Pb4

In the present case, the stapleless binder 5B actually moves from the dual-flat-binding position Pb2 to the corner-oblique-binding position Pb4.

In the present case, the second conjugate movement mechanism 8 behaves such that a portion of the binder 5 (5B) that is moving comes into contact with the first contact portion 812 of the rotatable lever 81.

Specifically, the rear corner 55r of the body 55 of the stapleless binder 5B comes into contact with the first contact surface 812a of the first contact portion 812 (see FIG. 19).

Accordingly, the rotatable lever 81 is pushed at the first contact portion 812 thereof in the second specific direction E2c and starts to rotate in the direction N1. With the rotation of the rotatable lever 81, the swingable lever 83 starts to swing in the direction Q1.

This swing is implemented by the distal end 813b of the second contact portion 813 of the rotatable lever 81 pushing the cam surface 832a of the cam portion 832 of the swingable lever 83.

This movement progresses in conjunction with the movement of the binder 5 (5B) in the second specific direction E2c.

In this phase, the rotatable lever 81 and the swingable lever 83 move such that the first contact portion 812 and the pushing portion 833 go away from each other.

The first contact portion 812 of the rotatable lever 81 moves in the direction E2, which is the rearward widthwise direction E. The pushing portion 833 of the swingable lever 83 moves in the direction E1, which is the frontward widthwise direction E.

The above behavior is exemplified in FIGS. 20A and 20B.

Furthermore, in the second conjugate movement mechanism 8, the swing of the swingable lever 83 in the direction Q1 pushes the movable member 435.

The pushing by the swingable lever 83 is implemented by the contact surface 833a of the pushing portion 833 coming into contact with and sliding on a portion of the movable member 435.

Thus, the movable member 435 moves in the direction E1c opposite to the second specific direction E2c while being guided along the second guide bar 405.

This movement of the movable member 435 stretches the movement urging member 87 and gradually increases the urging force Fe.

In this phase, the binder 5 (5B) moves in the direction E2 toward the corner-oblique-binding position Pb4. This movement is implemented with the activation of the mover-supporter 6 and the guiding along the second curved guide portion 643 of the guide groove 64 provided in the orientation guide plate 63.

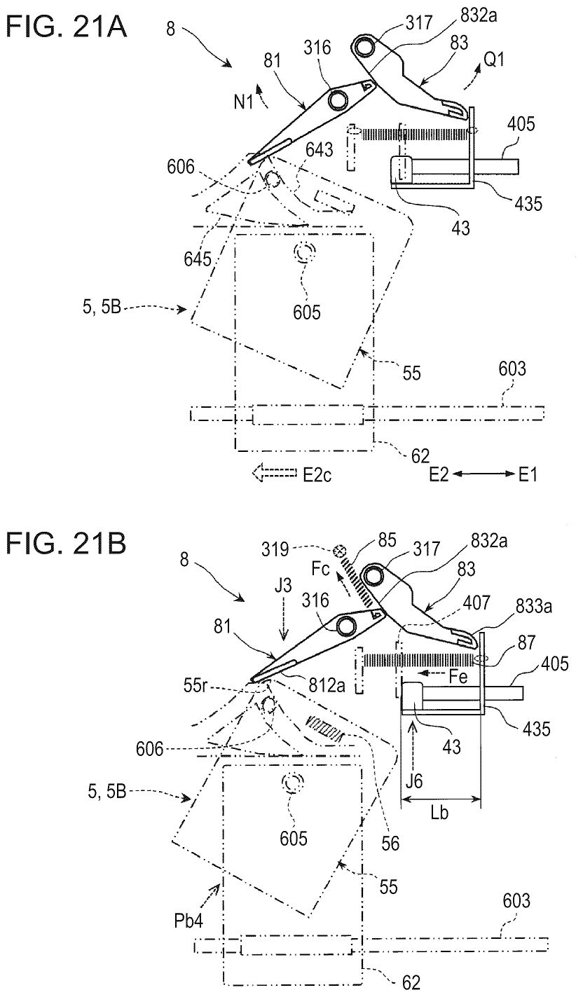

When the binder 5 (5B) reaches the corner-oblique-binding position Pb4 (see FIG. 21B), the binder 5 (5B) stops there and performs an oblique binding operation.

The above behavior of the second conjugate movement mechanism 8 ends when the binder 5 (5B) stops (see FIG. 21B).

In the present case, the rotatable lever 81 stops after being pushed by the corner 55r of the body 55 of the binder 5 (5B) and rotating in the direction N1 by a substantially maximum amount. Furthermore, the swingable lever 83 stops after being pushed by the rotatable lever 81 and swinging in the direction Q1 by a substantially maximum amount.

Furthermore, the rotation urging member 85 is stretched while swinging about the catcher 319 in the direction E1, which is the frontward widthwise direction E, thereby exerting the urging force Fc. The rotatable lever 81 receives the thus exerted urging force Fc acting to rotate the rotatable lever 81 in the direction N2.

Furthermore, the movement of the movable member 435 stretches the movement urging member 87 by the maximum amount, whereby the urging force Fe is maximized. The movable member 435 receives the maximized urging force Fe acting to pull back the movable member 435 in the direction E2.

Thus, the second conjugate movement mechanism 8 moves the lower-end-receiving member 43 by moving the movable member 435.

In the present case, the lower-end-receiving member 43 is moved in the direction E1c opposite to the second specific direction E2c (see FIGS. 20A, 20B, 21A, and 21B).

In the present case, the lower-end-receiving member 43 is moved from the normal position J3 by a predetermined distance Lb (see FIG. 21B).

Thus, the lower-end-receiving member 43 is moved to the avoiding position J6 and stops there (see FIG. 21A).

The avoiding position J6 is defined for the lower-end-receiving member 43 to avoid hindering the binder 5 (5B) from performing a binding operation at the corner-oblique-binding position Pb4.

In the sheet processing device 2A, when the binder 5 (5B) moves to the corner-oblique-binding position Pb4, the lower-end-receiving member 43 moves to the avoiding position J6.

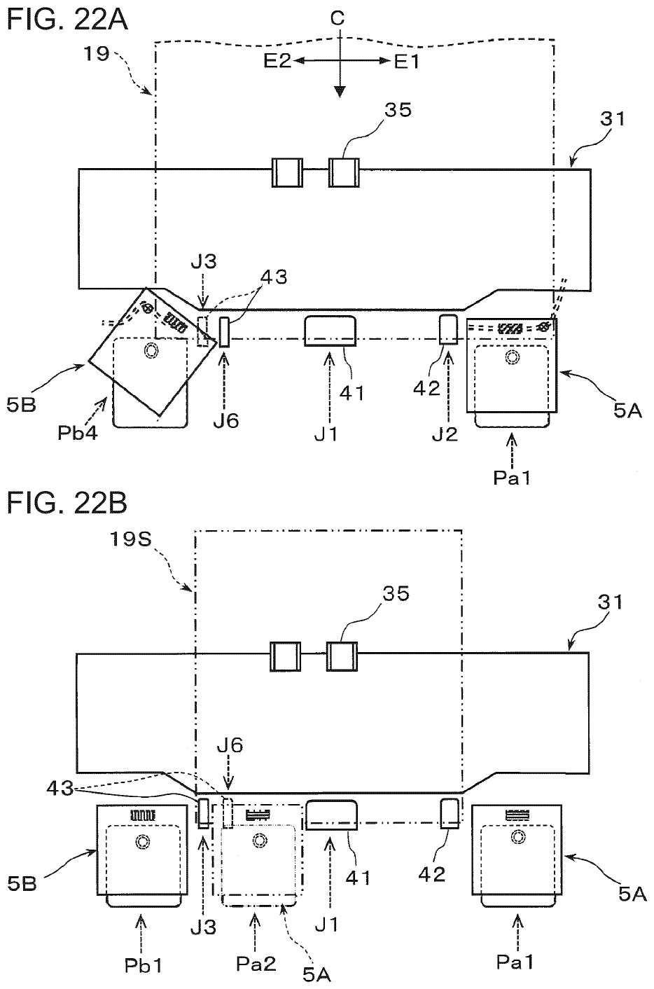

That is, the lower-end-receiving member 43 that is at the normal position J3 is moved to the avoiding position J6 in conjunction with the movement of the binder 5 (5B). This behavior is exemplified in FIG. 22A.

(b) Case where Binder 5 (5B) Moves from Corner-Oblique-Binding Position Pb4 to Standby Position Pb1

In the present case, the binder 5 (5B) moves to the standby position Pb1 after the completion of the binding operation performed at the corner-oblique-binding position Pb4. In other words, the binder 5 (5B) further moves in the second specific direction E2c by a distance greater than the predetermined distance Lb.

In the present case, the state of contact between a portion of the binder 5 (5B) and the first contact portion 812 of the rotatable lever 81 changes.

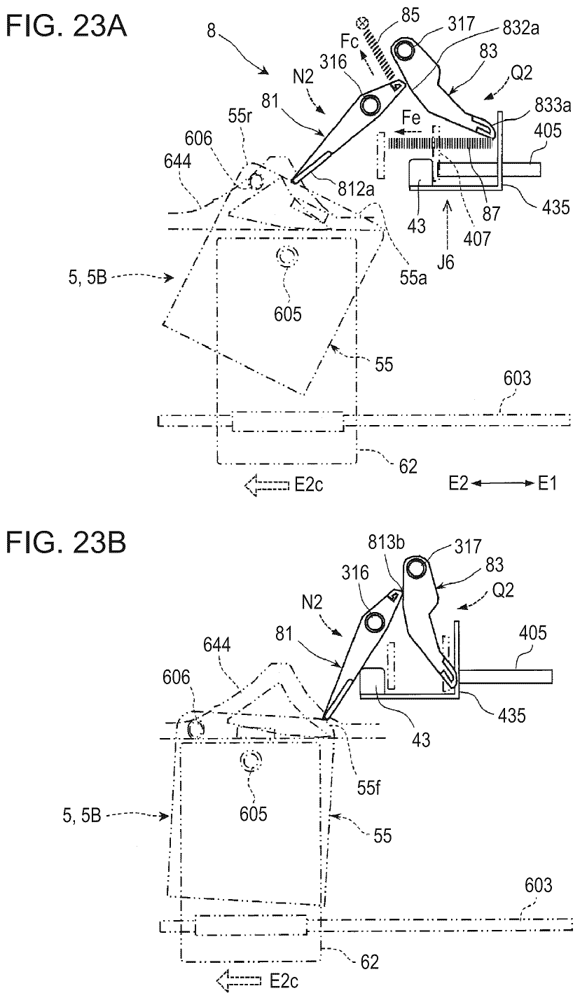

In the present case, the binder 5 (5B) moves in the direction E2 toward the standby position Pb1 (see FIGS. 23A, 23B, and 24A). This movement is implemented with the activation of the mover-supporter 6 and the guiding along the third curved guide portion 644 of the guide groove 64 provided in the orientation guide plate 63.

As the binder 5 (5B) moves in the direction E2, the binder 5 (5B) starts to go away from the rotatable lever 81.

With this movement, the point of contact between the first contact portion 812 of the rotatable lever 81 and the body 55 of the binder 5 (5B) changes from the corner 55r to the lateral face 55a.

In this phase, the stapleless binding parts 56 and 57 of the binder 5 (5B) moving in the direction E2 are inclined toward the front side. That is, the lateral face 55a of the body 55 of the binder 5 (5B) is located farther from the first shaft 316 than the corner 55r is.

Meanwhile, the rotatable lever 81 loses the external force exerted for the rotation thereof in the direction N1 and starts to rotate in the direction N2. In this phase, the rotatable lever 81 is under the urging force Fc exerted by the rotation urging member 85 and therefore tends to rotate in the direction N2.

With the rotation of the rotatable lever 81 in the direction N2, the swingable lever 83 starts to swing in a direction Q2.

The movement in this phase is implemented by the second contact portion 813 of the rotatable lever 81 moving on the cam surface 832a of the cam portion 832 of the swingable lever 83.

The above behavior is exemplified in FIG. 23A.

In this phase, the rotatable lever 81 and the swingable lever 83 behave such that the first contact portion 812 and the pushing portion 833 move toward each other.

The first contact portion 812 of the rotatable lever 81 moves in the direction E1, which is the frontward widthwise direction E. The pushing portion 833 of the swingable lever 83 moves in the direction E2, which is the rearward widthwise direction E2.

In the second conjugate movement mechanism 8, since the swingable lever 83 swings in the direction Q2, the pushing portion 833 stops pushing the movable member 435.

With the swing of the swingable lever 83 in the direction Q2, the movable member 435 starts to move in the direction E2.

The movement of the movable member 435 in this phase is implemented by the urging force Fe of the movement urging member 87.

Thus, the movable member 435 is pulled back in the direction E2 while being guided along the second guide bar 405.

With this movement of the movable member 435 in the direction E2, the movement urging member 87 starts to contract. Accordingly, the urging force Fe of the movement urging member 87 gradually decreases.

Subsequently, the binder 5 (5B) reaches the standby position Pb1 and stops there (see FIG. 24A).

Before reaching the standby position Pb1, the binder 5 (5B) goes out of contact with the first contact portion 812 of the rotatable lever 81. Specifically, the first contact portion 812 of the rotatable lever 81 goes out of contact with the body 55 when the corner 55f of the body 55 moves past the first contact portion 812.

This phase is exemplified in FIG. 24A.

Immediately before the binder 5 (5B) reaches the standby position Pb1, the second conjugate movement mechanism 8 resumes its normal position (see FIG. 24A).

In this phase, the rotatable lever 81 stops rotating in the direction N2 and returns to the normal position. Accordingly, the rotatable lever 81 stops pushing the swingable lever 83.

In conjunction with the movement of the rotatable lever 81, the swingable lever 83 stops swinging in the direction Q2 and returns to the normal position.

Furthermore, the movable member 435 comes into contact with the holding portion 407 and thus stops moving in the second specific direction E2c, thereby returning to the normal position.

Thus, the second conjugate movement mechanism 8 moves the lower-end-receiving member 43 back to the normal position by moving the movable member 435.

In the present case, the lower-end-receiving member 43 is moved in the second specific direction E2c (see FIGS. 23A, 23B, and 24A).

Furthermore, the lower-end-receiving member 43 is moved from the avoiding position J6 by the predetermined distance Lb (see FIG. 21B).

Thus, the lower-end-receiving member 43 is moved from the avoiding position J6 to the normal position J3 and stops there (see FIG. 24A).

Furthermore, in the sheet processing device 2A, the binder 5 (5A) becomes ready to move to the dual-flat-binding position Pa2 and perform a binding action.

This phase is exemplified in FIG. 22B by two-dot chain lines.

(c) Case where Binder 5 (5B) Moves from Standby Position Pb1 in Direction E1c Opposite to Second Specific Direction E2c

In the present case, the binder 5 (5B) moves from the standby position Pb1 and past the lower-end-receiving member 43. Moving past the lower-end-receiving member 43 is also regarded as moving toward the dual-flat-binding position Pb2 or Pb3.

In the present case, a portion of the binder 5 (5B) that is moving comes into contact with the second contact surface 812b of the first contact portion 812 of the rotatable lever 81. The portion of the binder 5 (5B) in the present case is the front corner 55f of the body 55.

In the present case, the binder 5 (5B) moves in the opposite direction E1c toward the dual-flat-binding position Pb2 or the like. This movement is implemented with the activation of the mover-supporter 6 and the guiding along the linear guide portion 641 of the guide groove 64 provided in the orientation guide plate 63.

Thus, the binder 5 (5B) that is moving comes into contact with and pushes at the corner 55f of the body 55 thereof the second contact surface 812b of the rotatable lever 81.

Accordingly, the rotatable lever 81 starts to rotate in the direction N2.

In this phase, the second contact portion 813 of the rotatable lever 81 is out of contact with the cam surface 832a of the swingable lever 83.

Meanwhile, the rotation of the rotatable lever 81 in the direction N2 does not push the swingable lever 83. Therefore, the swingable lever 83 does not swing.

The above behavior is exemplified in FIG. 24B.

Subsequently, the binder 5 (5B) further moves in the opposite direction E1c and thus cause the rotatable lever 81 to further rotate in the direction N2.

In this phase, the first contact portion 812 of the rotatable lever 81 is in contact with the lateral face 55a of the body 55 of the binder 5 (5B).

Furthermore, the first contact surface 812a of the rotatable lever 81 is brought close to or into contact with the inclined surface 833b of the swingable lever 83. In this phase, the swingable lever 83 does not swing yet, but the pushing portion 833 is kept in contact with the movable member 435.

Furthermore, the rotation urging member 85 is stretched rearward by being swung about the catcher 319, thereby exerting the urging force Fd.

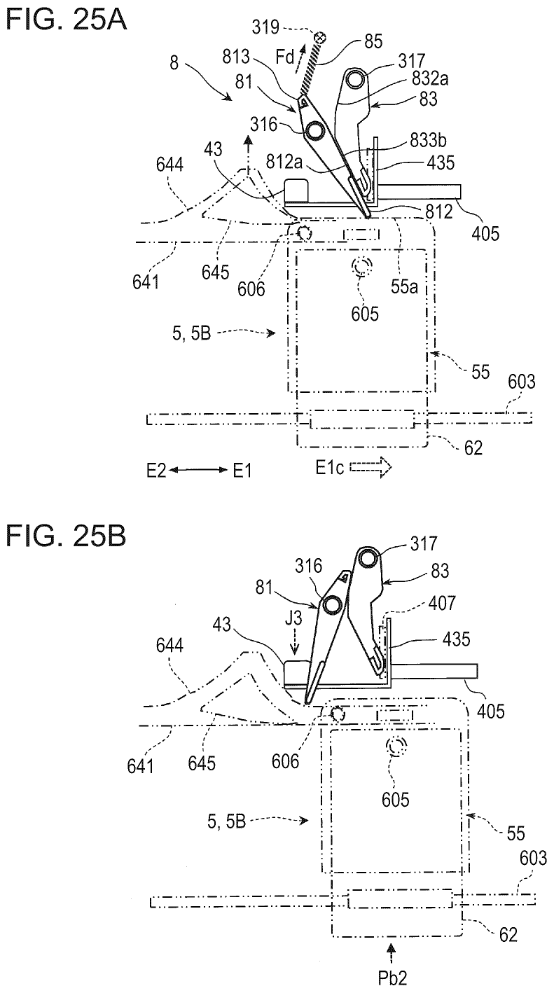

The above behavior is exemplified in FIG. 25A.

Subsequently, before the binder 5 (5B) reaches the dual-flat-binding position Pb2, the body 55 goes out of contact with the rotatable lever 81.

Accordingly, the rotatable lever 81 that is under the urging force Fd of the rotation urging member 85 rotates backward in the direction N1.

In this phase, the rotatable lever 81 comes into contact at the second contact portion 813 thereof with the cam portion 832 of the swingable lever 83 and thus stops.

The binder 5 (5B) stops when reaching the dual-flat-binding position Pb2.

Thus, the rotatable lever 81 rotates in conjunction with the above movement of the binder 5 (5B).

Nevertheless, the swingable lever 83 remains stationary without swinging, regardless of the above movement of the binder 5 (5B).

Accordingly, as with the swingable lever 83, the movable member 435 and the lower-end-receiving member 43 also remain stationary without moving.

That is, the lower-end-receiving member 43 in the present case keeps staying at the normal position J3.

To summarize, the second conjugate movement mechanism 8 does not move the lower-end-receiving member 43 when the binder 5 (5B) moves past the lower-end-receiving member 43 from the rear side.

The second conjugate movement mechanism 8 that behaves as described above is activated in conjunction with the movement of the binder 5 (5B).

Furthermore, the second conjugate movement mechanism 8 is positioned such that the distal end 813b of the second contact portion 813 of the rotatable lever 81 is in contact with the cam surface 832a of the cam portion 832 of the swingable lever 83 at a point near the second shaft 317 in normal times.

### (d) Other Features of Second Conjugate Movement Mechanism

The second conjugate movement mechanism 8 that behaves as described above is activated in conjunction with the movement of the binder 5 (5B).

Furthermore, the second conjugate movement mechanism 8 is positioned such that the distal end 813b of the rotatable lever 81 is in contact with the cam surface 832a of the swingable lever 83 at a point near the second shaft 317 in normal times.

Furthermore, in the second conjugate movement mechanism 8, the amount by which the swingable lever 83 swings with the rotation of the rotatable lever 81 in the direction N1 is greater in the first half of the swing than in the second half of the swing.

In other words, in the second conjugate movement mechanism 8, the amount by which the swingable lever 83 swings in the direction Q1 with the rotation of the rotatable lever 81 in the direction N1 is relatively large in the initial phase of the swing. Accordingly, the amount by which the movable member 435 is moved in the direction E1 is relatively large in the initial phase of the movement.

In such a configuration, the lower-end-receiving member 43 is movable by a relatively large amount in an early phase in the direction E1 opposite to the direction of movement of the binder 5(5B).

This effect is exemplified in FIG. 18B.

Reference sign Ptb given in FIG. 18B denotes a preliminary position that is reached by the binder 5 (5B) before a portion of the binder 5 (5B) moving toward the corner-oblique-binding position Pb4 comes into contact with the first contact surface 812a of the rotatable lever 81.

### (7-4) Other Configurations Relevant to Second Conjugate Movement Mechanism

In the sheet processing device 2A, the speed of travel of the binder 5 (5B) is adjusted in the movement approaching the corner-oblique-binding position Pb4 from the front side.

Specifically, the mover-supporter 6 reduces the speed of travel of the binder 5 (5B) before a portion of the binder 5 comes into contact with the first contact portion 812 of the rotatable lever 81. The adjustment of the speed of travel is implemented by reducing the driving speed of the drive source 661 of the mover-supporter 6 immediately before the contact.

The degree of adjustment of the speed of travel is exemplified in FIG. 26B.

Reference sign Ptb given in FIG. 26B denotes a preliminary position that is reached by the binder 5 (5B) before a portion of the binder 5 (5B) comes into contact with the first contact surface 812a of the first contact portion 812. FIG. 26B illustrates that the speed of travel is reduced at the preliminary position Ptb. In the case exemplified in FIG. 26B, the speed of travel is changed at the preliminary position Ptb from a low speed to a lower speed.

In the sheet processing device 2A, the speed of travel of the binder 5 (5B) is also adjusted in the movement from the standby position Pb1 to the dual-flat-binding position Pb2 or the like.

Specifically, the mover-supporter 6 reduces the speed of travel of the binder 5 (5B) before a portion of the binder 5 comes into contact with the first contact portion 812 of the rotatable lever 81. The contact with the first contact portion 812 in such a situation is the contact with the second contact surface 812b.

As described above, the sheet processing device 2A is provided on the inside (output accommodation part 15) of the housing 11 of the image forming apparatus 10A.

The sheet processing device 2A includes the second conjugate movement mechanism 8 configured to behave as described above.

### Second Exemplary Embodiment

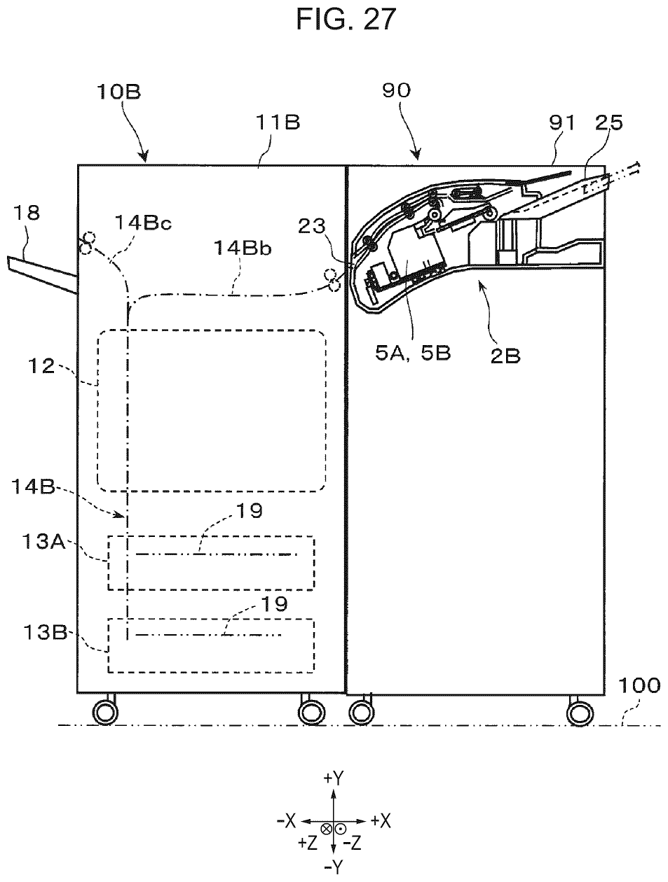

FIG. 27 is a schematic diagram of a post-processing apparatus 90 including a sheet processing device 2B according to a second exemplary embodiment of the present disclosure.

The post-processing apparatus 90 is provided outside an image forming apparatus 10B and is connected as a separate apparatus to the image forming apparatus 10B when in use.

The image forming apparatus 10B according to the second exemplary embodiment includes no sheet processing device 2A in a housing 11B. In the other respects, the image forming apparatus 10B has substantially the same configuration as the image forming apparatus 10A according to the first exemplary embodiment.

That is, the image forming apparatus 10B includes the housing 11B, the image forming section 12, and the sheet supplying section 13. The housing 11B is provided with an output tray 18, in replacement of the output accommodation part 15 according to the first exemplary embodiment. The output tray 18 projects to the outside of the housing 11B.

The post-processing apparatus 90 includes a housing 91, which has an external shape and an internal construction that are predetermined. In the post-processing apparatus 90, the sheet processing device 2B is located inside or in an upper part of the housing 91.

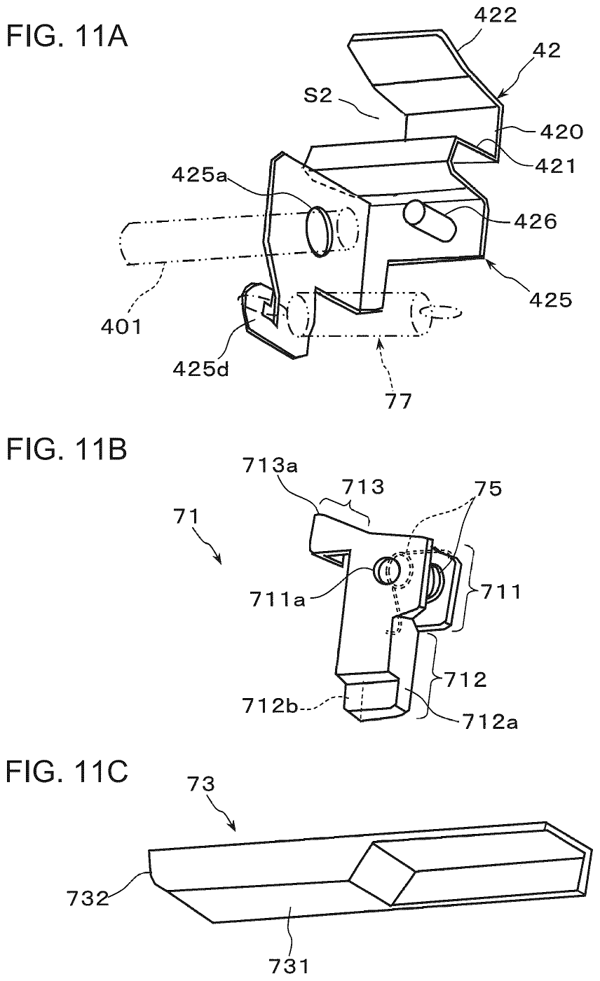

The sheet processing device 2B has substantially the same configuration as the sheet processing device 2A according to the first exemplary embodiment (see FIGS. 2 to 25A and 25B and others).

That is, the sheet processing device 2B includes the first conjugate movement mechanism 7 and the second conjugate movement mechanism 8. The sheet processing device 2B behaves in substantially the same manner as the sheet processing device 2A according to the first exemplary embodiment.

The image forming apparatus 10B includes a sheet transport path 14B inside the housing 11B. The sheet transport path 14B has substantially the same configuration as the sheet transport path 14 according to the first exemplary embodiment, except the following.

The sheet transport path 14B includes two output paths 14Bb and 14Bc. The output path 14Bb is configured to output the sheet 19 received from the image forming section 12 toward the sheet processing device 2B. The output path 14Bc is configured to output the sheet 19 received from the image forming section 12 toward the output tray 18.

The post-processing apparatus 90 is configured to introduce sheets 19 from the image forming apparatus 10B into the sheet processing device 2B and perform at least a binding operation on the sheets 19.

The post-processing apparatus 90 may include a device configured to perform an operation other than the binding operation.

### Variations

The present disclosure is not limited to the first and second exemplary embodiments described above. Various changes and modifications may be made to the present disclosure without changing the essence of the disclosure provided in this specification and the drawings.

For example, the present disclosure encompasses the following variations.

The sheet processing devices 2A and 2B may each employ a single binder 5.

This variation is based on a precondition that one lower-end-receiving member is located at such a position as to possibly hinder the single binder 5 from performing a binding operation at a predetermined binding position. The one lower-end-receiving member is, for example, the lower-end-receiving member 42 or 43.

If two binders 5 are employed, the two binders 5 may be based on the same binding scheme.

The configurations of the binder 5 regarding binding position, standby position, order of movements, destination of movement, and so forth are not limited to those defined in the first exemplary embodiment and others and may be changed.

The lower-end receiver 4 included in the sheet processing device 2A or 2B may be constituted by two or four or more lower-end-receiving members. The normal positions of the multiple lower-end-receiving members may be different from those defined in the first exemplary embodiment and others.

These variations are also based on the precondition that one lower-end-receiving member is located at such a position as to possibly hinder the binder 5 from performing a binding operation at a predetermined binding position.

One of the first conjugate movement mechanism 7 and the second conjugate movement mechanism 8 may be omitted. In such a variation, which of the two is to be omitted may be determined on the basis of, for example, the normal position of the one lower-end-receiving member where the binding action may be hindered.

The first conjugate movement mechanism 7 and the second conjugate movement mechanism 8 may each be provided in multiple quantities. Such a variation is applicable to a case where the binding action may be hindered by multiple lower-end-receiving members that are at the respective normal positions.

The second conjugate movement mechanism 8 is also active in a configuration where the other binder 5A is movable to the rear corner-oblique-binding position Pb4. During such a movement, the binder 5B stands by at the standby position Pb1.

The predetermined binding position for the binder 5 (5A or 5B) relative to the first conjugate movement mechanism 7 may be changed with the arrangement of the multiple lower-end-receiving members. For example, the predetermined binding position in such a variation may be the rear dual-flat-binding position Pa2 or Pb2. In such a variation, the one lower-end-receiving member may be, for example, the rear lower-end-receiving member 43.

The predetermined binding position for the binder 5 (5A or 5B) relative to the second conjugate movement mechanism 8 may also be changed with the arrangement of the multiple lower-end-receiving members. For example, the predetermined binding position in such a variation may be the front dual-flat-binding position Pa4. In such a variation, the one lower-end-receiving member may be, for example, the front lower-end-receiving member 42.

The sheet processing device 2A is not limited to the one installed in a part of the image forming apparatus 10A, and may be provided as a stand-alone sheet processing device.

In such a variation, for example, a supplying unit configured to supply sheets 19 to be bound may be added.

The image forming apparatuses 10A and 10B may each include an image forming section 12 employing an image forming scheme other than an electrophotographic scheme. Examples of other image forming schemes include inkjet scheme and printing scheme.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A sheet processing device comprising:
a collecting part configured to collect a plurality of sheets that are carried in;
a plurality of lower-end-receiving members with which lower ends of the sheets collected to the collecting part are brought into contact, the lower ends being downstream ends in a carry-in direction;
a binder configured to bind a part of an end portion of a sheet batch, the sheet batch being the plurality of sheets collected to the collecting part, the end portion including the lower ends; and
a mover-supporter supporting the binder and configured to move the binder around the end portion of the sheet batch in such a manner as to stop the binder at a plurality of stop positions including a plurality of binding positions,
wherein one of the plurality of lower-end-receiving members is provided on a movable member that is movable in a widthwise direction that intersects the carry-in direction,
wherein the one lower-end-receiving member is provided with a conjugate movement mechanism configured to move the one lower-end-receiving member in conjunction with a movement of the binder,
wherein, in response to the binder moving in a specific direction toward a predetermined binding position, the conjugate movement mechanism moves the one lower-end-receiving member in the specific direction from a normal position by a predetermined distance, and
wherein, in response to the binder moving by a distance greater than the predetermined distance, the conjugate movement mechanism returns the one lower-end-receiving member to the normal position.
   (((2)))

The sheet processing device according to (((1))),
wherein, during a movement of the binder past the one lower-end-receiving member in a direction opposite to the specific direction, the conjugate movement mechanism leaves the one lower-end-receiving member unmoved.
   (((3)))

The sheet processing device according to (((1))) or (((2))),
wherein the plurality of lower-end-receiving members are three lower-end-receiving members arranged separately from one another at three respective normal positions where the lower-end-receiving members are supposed to come into contact with a lower end of a sheet having a smallest possible width in a carry-in orientation of the sheet.
   (((4)))

The sheet processing device according to any one of (((1))) to (((3))),
wherein the predetermined distance is a distance from the normal position of the one lower-end-receiving member to at least an avoiding position where the one lower-end-receiving member avoids hindering the binder from stopping at the predetermined binding position and performing a binding operation.
   (((5)))

The sheet processing device according to any one of (((1))) to (((4))),
wherein the binder includes two binders, and
wherein the conjugate movement mechanism is activated in response to either of the two binders moving in the specific direction to the predetermined binding position.
   (((6)))

The sheet processing device according to (((5))),
wherein the two binders are a stapling binder and a stapleless binder, the stapling binder being configured to bind a part of the end portion of the sheet batch in a stapling manner, the stapleless binder being configured to bind a part of the end portion of the sheet batch in a stapleless manner.
   (((7)))

The sheet processing device according to (((6))),
wherein the mover-supporter supports the stapling binder and the stapleless binder while allowing the stapling binder and the stapleless binder to move in a depthwise direction heading from a front side toward a rear side of the sheet processing device in an installed orientation, and
wherein the stapling binder is located on the front side relative to the stapleless binder.
   (((8)))

The sheet processing device according to (((5))),
wherein the plurality of lower-end-receiving members are three lower-end-receiving members arranged separately from one another at three respective normal positions where the lower-end-receiving members are supposed to come into contact with a lower end of a sheet having a smallest possible width in a carry-in orientation of the sheet, and
wherein the one lower-end-receiving member is a front lower-end-receiving member located at a frontmost position among the three lower-end-receiving members in the sheet processing device in an installed orientation.
   (((9)))

The sheet processing device according to (((1))),
wherein the conjugate movement mechanism includes a rotatable lever; a rotation controlling member; a rotation urging member; and a movement urging member,
wherein the rotatable lever includes a bearing portion rotatably attached to a shaft included in the movable member; a first contact portion that is allowed, at a position away from the bearing portion, to come into contact with a portion of the binder that is moving; and a second contact portion that is in contact with the rotation controlling member at a position away from the bearing portion in a different direction from the first contact portion,
wherein the rotation controlling member is fixed at such a position as to face the second contact portion of the rotatable lever and includes a first controlling surface and a second controlling surface, the first controlling surface being provided for the second contact portion to come into contact with, the first controlling surface controlling the rotatable lever to stop rotating in one direction while allowing the rotatable lever to move by at least the predetermined distance, the second controlling surface adjoining a terminal end of the first controlling surface and controlling the rotatable lever to rotate in the one direction,
wherein the rotation urging member is configured to apply to the rotatable lever an urging force that rotates the rotatable lever in the one direction, and
wherein the movement urging member is configured to apply to the movable member an urging force that moves the one lower-end-receiving member back to the normal position.
   (((10)))

The sheet processing device according to (((9))),
wherein a first smallest length L1 and a second smallest length L2 are in a relationship of L1<L2, the first smallest length L1 being a length between a first contact point and an axis of the shaft, the first contact point being a point closest to the shaft in a part of the first contact portion where the first contact portion comes into contact with the portion of the binder, the second smallest length L2 being a length between a second contact point and the axis of the shaft, the second contact point being a point closest to the shaft in a part of the second contact portion where the second contact portion comes into contact with the first controlling surface.
   (((11)))

The sheet processing device according to (((9))) or (((10))),
wherein the mover-supporter while moving the binder reduces a speed of travel of the binder before the portion of the binder comes into contact with the first contact portion of the rotatable lever.
   (((12)))

An image forming apparatus comprising:
a housing;
an image forming section provided inside the housing and configured to form an image on a sheet; and
the sheet processing device according to any one of (((1))) to (((11))), the sheet processing device being provided inside the housing and configured to perform a binding operation on the sheet outputted from the image forming section.
   (((13)))

The image forming apparatus according to (((12))),
wherein the plurality of lower-end-receiving members are three lower-end-receiving members,
wherein the binder includes two binders,
wherein the mover-supporter supports the two binders while allowing the two binders to move in a depthwise direction heading from a front side toward a rear side of the image forming apparatus in an installed orientation, and
wherein the one lower-end-receiving member is a front lower-end-receiving member located at a frontmost position among the three lower-end-receiving members.
   (((14)))

The image forming apparatus according to (((12))) or (((13))),
wherein the sheet processing device includes a covering that is separate from the housing, and
wherein the covering includes a top face serving as an accommodation part that is capable of accommodating the sheet transported through and outputted from the image forming section.
   (((15)))

A post-processing apparatus comprising:
the sheet processing device according to any one of (((1))) to (((11))),
wherein the post-processing apparatus is provided outside an image forming apparatus configured to form an image on a sheet and is connected as a separate device to the image forming apparatus, and
wherein the post-processing apparatus is configured to introduce into the sheet processing device the sheet outputted from the image forming apparatus and to perform a binding operation on the sheet.

What is claimed is:

1. A sheet processing device comprising:
a collecting part configured to collect a plurality of sheets that are carried in;
a plurality of lower-end-receiving members with which lower ends of the sheets collected to the collecting part are brought into contact, the lower ends being downstream ends in a carry-in direction;
a binder configured to bind a part of an end portion of a sheet batch, the sheet batch being the plurality of sheets collected to the collecting part, the end portion including the lower ends; and
a mover-supporter supporting the binder and configured to move the binder around the end portion of the sheet batch in such a manner as to stop the binder at a plurality of stop positions including a plurality of binding positions,
wherein one of the plurality of lower-end-receiving members is provided on a movable member that is movable in a widthwise direction that intersects the carry-in direction,
wherein the one lower-end-receiving member is provided with a conjugate movement mechanism configured to move the one lower-end-receiving member in conjunction with a movement of the binder,
wherein, in response to the binder moving in a specific direction toward a predetermined binding position, the conjugate movement mechanism moves the one lower-end-receiving member in the specific direction from a normal position by a predetermined distance, and
wherein, in response to the binder moving by a distance greater than the predetermined distance, the conjugate movement mechanism returns the one lower-end-receiving member to the normal position.

2. The sheet processing device according to claim 1,
wherein, during a movement of the binder past the one lower-end-receiving member in a direction opposite to the specific direction, the conjugate movement mechanism leaves the one lower-end-receiving member unmoved.

3. The sheet processing device according to claim 1,
wherein the plurality of lower-end-receiving members are three lower-end-receiving members arranged separately from one another at three respective normal positions where the lower-end-receiving members are supposed to come into contact with a lower end of a sheet having a smallest possible width in a carry-in orientation of the sheet.

4. The sheet processing device according to claim 1,
wherein the predetermined distance is a distance from the normal position of the one lower-end-receiving member to at least an avoiding position where the one lower-end-receiving member avoids hindering the binder from stopping at the predetermined binding position and performing a binding operation.

5. The sheet processing device according to claim 1,
wherein the binder includes two binders, and
wherein the conjugate movement mechanism is activated in response to either of the two binders moving in the specific direction to the predetermined binding position.

6. The sheet processing device according to claim 5,
wherein the two binders are a stapling binder and a stapleless binder, the stapling binder being configured to bind a part of the end portion of the sheet batch in a stapling manner, the stapleless binder being configured to bind a part of the end portion of the sheet batch in a stapleless manner.

7. The sheet processing device according to claim 6,
wherein the mover-supporter supports the stapling binder and the stapleless binder while allowing the stapling binder and the stapleless binder to move in a depthwise direction heading from a front side toward a rear side of the sheet processing device in an installed orientation, and
wherein the stapling binder is located on the front side relative to the stapleless binder.

8. The sheet processing device according to claim 5,
wherein the plurality of lower-end-receiving members are three lower-end-receiving members arranged separately from one another at three respective normal positions where the lower-end-receiving members are supposed to come into contact with a lower end of a sheet having a smallest possible width in a carry-in orientation of the sheet, and
wherein the one lower-end-receiving member is a front lower-end-receiving member located at a frontmost position among the three lower-end-receiving members in the sheet processing device in an installed orientation.

9. The sheet processing device according to claim 1,
wherein the conjugate movement mechanism includes a rotatable lever; a rotation controlling member; a rotation urging member; and a movement urging member,
wherein the rotatable lever includes a bearing portion rotatably attached to a shaft included in the movable member; a first contact portion that is allowed, at a position away from the bearing portion, to come into contact with a portion of the binder that is moving; and a second contact portion that is in contact with the rotation controlling member at a position away from the bearing portion in a different direction from the first contact portion,
wherein the rotation controlling member is fixed at such a position as to face the second contact portion of the rotatable lever and includes a first controlling surface and a second controlling surface, the first controlling surface being provided for the second contact portion to come into contact with, the first controlling surface controlling the rotatable lever to stop rotating in one direction while allowing the rotatable lever to move by at least the predetermined distance, the second controlling surface adjoining a terminal end of the first controlling surface and controlling the rotatable lever to rotate in the one direction,
wherein the rotation urging member is configured to apply to the rotatable lever an urging force that rotates the rotatable lever in the one direction, and
wherein the movement urging member is configured to apply to the movable member an urging force that moves the one lower-end-receiving member back to the normal position.

10. The sheet processing device according to claim 9,
wherein a first smallest length L1 and a second smallest length L2 are in a relationship of L1<L2, the first smallest length L1 being a length between a first contact point and an axis of the shaft, the first contact point being a point closest to the shaft in a part of the first contact portion where the first contact portion comes into contact with the portion of the binder, the second smallest length L2 being a length between a second contact point and the axis of the shaft, the second contact point being a point closest to the shaft in a part of the second contact portion where the second contact portion comes into contact with the first controlling surface.

11. The sheet processing device according to claim 9,
wherein the mover-supporter while moving the binder reduces a speed of travel of the binder before the portion of the binder comes into contact with the first contact portion of the rotatable lever.

12. An image forming apparatus comprising:
a housing;
an image forming section provided inside the housing and configured to form an image on a sheet; and
the sheet processing device according to claim 1, the sheet processing device being provided inside the housing and configured to perform a binding operation on the sheet outputted from the image forming section.

13. An image forming apparatus comprising:
a housing;
an image forming section provided inside the housing and configured to form an image on a sheet; and
the sheet processing device according to claim 2, the sheet processing device being provided inside the housing and configured to perform a binding operation on the sheet outputted from the image forming section.

14. An image forming apparatus comprising:
a housing;
an image forming section provided inside the housing and configured to form an image on a sheet; and
the sheet processing device according to claim 3, the sheet processing device being provided inside the housing and configured to perform a binding operation on the sheet outputted from the image forming section.

15. An image forming apparatus comprising:
a housing;
an image forming section provided inside the housing and configured to form an image on a sheet; and
the sheet processing device according to claim 4, the sheet processing device being provided inside the housing and configured to perform a binding operation on the sheet outputted from the image forming section.

16. An image forming apparatus comprising:
a housing;
an image forming section provided inside the housing and configured to form an image on a sheet; and
the sheet processing device according to claim 5, the sheet processing device being provided inside the housing and configured to perform a binding operation on the sheet outputted from the image forming section.

17. An image forming apparatus comprising:
a housing;
an image forming section provided inside the housing and configured to form an image on a sheet; and
the sheet processing device according to claim 6, the sheet processing device being provided inside the housing and configured to perform a binding operation on the sheet outputted from the image forming section.

18. The image forming apparatus according to claim 12,
wherein the plurality of lower-end-receiving members are three lower-end-receiving members,
wherein the binder includes two binders,
wherein the mover-supporter supports the two binders while allowing the two binders to move in a depthwise direction heading from a front side toward a rear side of the image forming apparatus in an installed orientation, and
wherein the one lower-end-receiving member is a front lower-end-receiving member located at a frontmost position among the three lower-end-receiving members.

19. The image forming apparatus according to claim 12,
wherein the sheet processing device includes a covering that is separate from the housing, and
wherein the covering includes a top face serving as an accommodation part that is capable of accommodating the sheet transported through and outputted from the image forming section.

20. A post-processing apparatus comprising:
the sheet processing device according to claim 1,
wherein the post-processing apparatus is provided outside an image forming apparatus configured to form an image on a sheet and is connected as a separate device to the image forming apparatus, and
wherein the post-processing apparatus is configured to introduce into the sheet processing device the sheet outputted from the image forming apparatus and to perform a binding operation on the sheet.
